(19) United States
(12) Patent Application Publication
(10) Pub. No.: US 2024/0357122 A1
(43) Pub. Date: Oct. 24, 2024

(54) OPTICAL FLOW-BASED MOTION REFINEMENT

(71) Applicant: Alibaba Innovation Private Limited, Singapore (SG)

(72) Inventors: Jie CHEN, Beijing (CN); Ru-Ling LIAO, Beijing (CN); Xinwei LI, Beijing (CN); Yan YE, San Diego, CA (US)

(21) Appl. No.: 18/628,086

(22) Filed: Apr. 5, 2024

Related U.S. Application Data
(60) Provisional application No. 63/495,768, filed on Apr. 12, 2023.
(60) Provisional application No. 63/508,010, filed on Jun. 14, 2023.

(51) Int. Cl. H04N 19/137; H04N 19/176; H04N 19/192

(52) U.S. Cl. CPC H04N 19/137; H04N 19/176; H04N 19/192

(57) ABSTRACT

Methods and apparatuses are provided for optical flow-based motion refinement. An exemplary method includes: dividing a coding block into a first set of subblocks and a second set of subblocks; performing a first pass of optical flow-based motion vector refinement on the first set of subblocks; and performing a second pass of optical flow-based motion vector refinement on the second set of subblocks.

### CROSS-REFERENCE TO RELATED APPLICATIONS

The disclosure claims the benefits of priority to: U.S. Provisional Application No. 63/495,768, filed on Apr. 12, 2023, and U.S. Provisional Application No. 63/508,010, filed on Jun. 14, 2023, the contents of all of which are incorporated herein by reference in their entireties.

### TECHNICAL FIELD

The present disclosure generally relates to video processing, and more particularly, to methods and apparatuses for optical flow-based motion refinement.

### BACKGROUND

A video is a set of static pictures (or “frames”) capturing the visual information. To reduce the storage memory and the transmission bandwidth, a video can be compressed before storage or transmission and decompressed before display. The compression process is usually referred to as encoding and the decompression process is usually referred to as decoding. There are various video coding formats which use standardized video coding technologies, most commonly based on prediction, transform, quantization, entropy coding and in-loop filtering. The video coding standards, such as the High Efficiency Video Coding (HEVC/H.265) standard, the Versatile Video Coding (VVC/H.266) standard, AVS standards, specifying the specific video coding formats, are developed by standardization organizations. With more and more advanced video coding technologies being adopted in the video standards, the coding efficiency of the new video coding standards get higher and higher.

### SUMMARY OF THE DISCLOSURE

Embodiments of the present disclosure provide methods and apparatuses for optical flow-based motion refinement.

According to some exemplary embodiments, there is provided a video processing method including: dividing a coding block into a first set of subblocks and a second set of subblocks; performing a first pass of optical flow-based motion vector refinement on the first set of subblocks; and performing a second pass of optical flow-based motion vector refinement on the second set of subblock.

According to some exemplary embodiments, there is provided an apparatus including: a memory storing computer instructions; and one or more processors configured to execute the computer instructions. The the execution of the computer instruction causes the apparatus to perform operations including: dividing a coding block into a first set of subblocks and a second set of subblocks; performing a first pass of optical flow-based motion vector refinement on the first set of subblocks; and performing a second pass of optical flow-based motion vector refinement on the second set of subblock.

According to some exemplary embodiments, there is provided a non-transitory computer readable storage medium storing a bitstream of a video. The bitstream is for processing according to a method including: dividing a coding block into a first set of subblocks and a second set of subblocks; performing a first pass of optical flow-based motion vector refinement on the first set of subblocks; and performing a second pass of optical flow-based motion vector refinement on the second set of subblock.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram illustrating structures of an example video sequence, according to some embodiments of the present disclosure.

FIG. 2A is a schematic diagram illustrating an example encoding process of a hybrid video coding system, according to some embodiments of the present disclosure.

FIG. 2B is a schematic diagram illustrating another example encoding process of a hybrid video coding system, according to some embodiments of the present disclosure.

FIG. 3A is a schematic diagram illustrating an example decoding process of a hybrid video coding system, according to some embodiments of the present disclosure.

FIG. 3B is a schematic diagram illustrating another example decoding process of a hybrid video coding system, according to some embodiments of the present disclosure.

FIG. 4 is a block diagram of an example apparatus for encoding or decoding a video, according to some embodiments of the present disclosure.

FIG. 5 is a schematic diagram illustrating an extended coding unit (CU) region used in bi-directional optical flow (BDOF), according to some embodiments of the present disclosure.

FIG. 6 is a schematic diagram illustrating a decoding-side motion vector refinement (DMVR) process, according to some embodiments of the present disclosure.

FIG. 7 is a schematic diagram illustrating a 3×3 square search pattern, according to some embodiments of the present disclosure.

FIG. 8 is a schematic diagram illustrating diamond regions in a search area for refined motion vectors (MV), according to some embodiments of the present disclosure.

FIG. 9 is a flowchart of an exemplary method for performing motion vector refinement and motion compensation, according to some embodiments of the present disclosure.

FIG. 10 is a flowchart of an exemplary method for performing motion vector refinement and motion compensation, according to some embodiments of the present disclosure.

FIG. 11 is a flowchart of another exemplary method for performing motion vector refinement and motion compensation, according to some embodiments of the present disclosure.

FIGS. 12A and 12B are schematic diagrams illustrating a process for dividing a predicted block by using an extended predicted block, according to some embodiments of the present disclosure.

FIGS. 13A and 13B are schematic diagrams illustrating a process for dividing a predicted block by using an extended predicted block, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms or definitions incorporated by reference.

The embodiments provided by the present disclosure are directed to encoding and decoding video information, and more particularly, to methods and systems for performing optical flow-based motion vector refinement. The disclosed methods perform multiple passes of optical flow-based motion vector refinement, and adaptively the subblock grid size, thereby leading to more stable results in the optical flow calculation.

For reducing the storage space and the transmission bandwidth needed by such applications, the video can be compressed before storage and transmission and decompressed before the display. The compression and decompression can be implemented by software executed by a processor (e.g., a processor of a generic computer) or specialized hardware. The module for compression is generally referred to as an “encoder,” and the module for decompression is generally referred to as a “decoder.” The encoder and decoder can be collectively referred to as a “codec.” The encoder and decoder can be implemented as any of a variety of suitable hardware, software, or a combination thereof. For example, the hardware implementation of the encoder and decoder can include circuitry, such as one or more microprocessors, digital signal processors (DSPs), application-specific integrated circuits (ASICs), field-programmable gate arrays (FPGAs), discrete logic, or any combinations thereof. The software implementation of the encoder and decoder can include program codes, computer-executable instructions, firmware, or any suitable computer-implemented algorithm or process fixed in a computer-readable medium. Video compression and decompression can be implemented by various algorithms or standards, such as MPEG-1, MPEG-2, MPEG-4, H.26x, AVS series, or the like. In some applications, the codec can decompress the video from a first coding standard and re-compress the decompressed video using a second coding standard, in which case the codec can be referred to as a “transcoder.”

The video encoding process can identify and keep useful information that can be used to reconstruct a picture and disregard unimportant information for the reconstruction. If the disregarded, unimportant information cannot be fully reconstructed, such an encoding process can be referred to as “lossy.” Otherwise, it can be referred to as “lossless.” Most encoding processes are lossy, which is a tradeoff to reduce the needed storage space and the transmission bandwidth.

The useful information of a picture being encoded (referred to as a “current picture”) include changes with respect to a reference picture (e.g., a picture previously encoded and reconstructed). Such changes can include position changes, luminosity changes, or color changes of the pixels, among which the position changes are mostly concerned. Position changes of a group of pixels that represent an object can reflect the motion of the object between the reference picture and the current picture.

A picture coded without referencing another picture (i.e., it is its own reference picture) is referred to as an “I-picture.” A picture is referred to as a “P-picture” if some or all blocks (e.g., blocks that generally refer to portions of the video picture) in the picture are predicted using intra prediction or inter prediction with one reference picture (e.g., uni-prediction). A picture is referred to as a “B-picture” if at least one block in it is predicted with two reference pictures (e.g., bi-prediction).

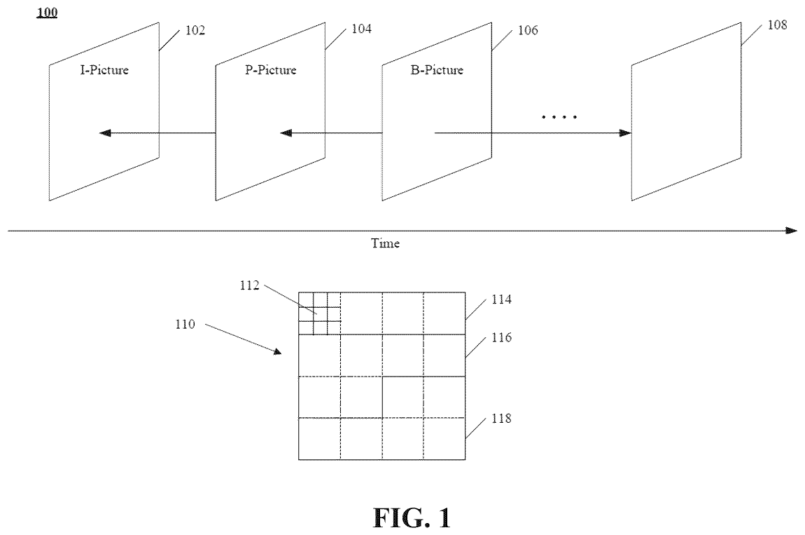

FIGS. 1, 2A, 2B, 3A, 3B, and 4 illustrate the general aspects of the video encoding/decoding apparatuses and processes used in the disclosed embodiments. Specifically, FIG. 1 illustrates structures of an example video sequence 100, according to some embodiments of the present disclosure. Video sequence 100 can be a live video or a video having been captured and archived. Video 100 can be a real-life video, a computer-generated video (e.g., computer game video), or a combination thereof (e.g., a real-life video with augmented-reality effects). Video sequence 100 can be inputted from a video capture device (e.g., a camera), a video archive (e.g., a video file stored in a storage device) containing previously captured video, or a video feed interface (e.g., a video broadcast transceiver) to receive video from a video content provider.

As shown in FIG. 1, video sequence 100 can include a series of pictures arranged temporally along a timeline, including pictures 102, 104, 106, and 108. Pictures 102-106 are continuous, and there are more pictures between pictures 106 and 108. In FIG. 1, picture 102 is an I-picture, the reference picture of which is picture 102 itself. Picture 104 is a P-picture, the reference picture of which is picture 102, as indicated by the arrow. Picture 106 is a B-picture, the reference pictures of which are pictures 104 and 108, as indicated by the arrows. In some embodiments, the reference picture of a picture (e.g., picture 104) can be not immediately preceding or following the picture. For example, the reference picture of picture 104 can be a picture preceding picture 102. It should be noted that the reference pictures of pictures 102-106 are only examples, and the present disclosure does not limit embodiments of the reference pictures as the examples shown in FIG. 1.

Typically, video codecs do not encode or decode an entire picture at one time due to the computing complexity of such tasks. Rather, they can split the picture into basic segments, and encode or decode the picture segment by segment. Such basic segments are referred to as basic processing units (“BPUs”) in the present disclosure. For example, structure 110 in FIG. 1 shows an example structure of a picture of video sequence 100 (e.g., any of pictures 102-108). In structure 110, a picture is divided into 4×4 basic processing units, the boundaries of which are shown as dash lines. In some embodiments, the basic processing units can be referred to as “macroblocks” in some video coding standards (e.g., MPEG family, H.261, H.263, or H.264/AVC), or as “coding tree units” (“CTUs”) in some other video coding standards (e.g., H.265/HEVC, H.266/VVC, or AVS). The basic processing units can have variable sizes in a picture, such as 128×128, 64×64, 32×32, 16×16, 4×8, 16×32, or any arbitrary shape and size of pixels. The sizes and shapes of the basic processing units can be selected for a picture based on the balance of coding efficiency and levels of details to be kept in the basic processing unit.

The basic processing units can be logical units, which can include a group of different types of video data stored in a computer memory (e.g., in a video frame buffer). For example, a basic processing unit of a color picture can include a luma component (Y) representing achromatic brightness information, one or more chroma components (e.g., Cb and Cr) representing color information, and associated syntax elements, in which the luma and chroma components can have the same size of the basic processing unit. The luma and chroma components can be referred to as “coding tree blocks” (“CTBs”) in some video coding standards (e.g., H.265/HEVC, H.266/VVC or AVS). Any operation performed to a basic processing unit can be repeatedly performed to each of its luma and chroma components.

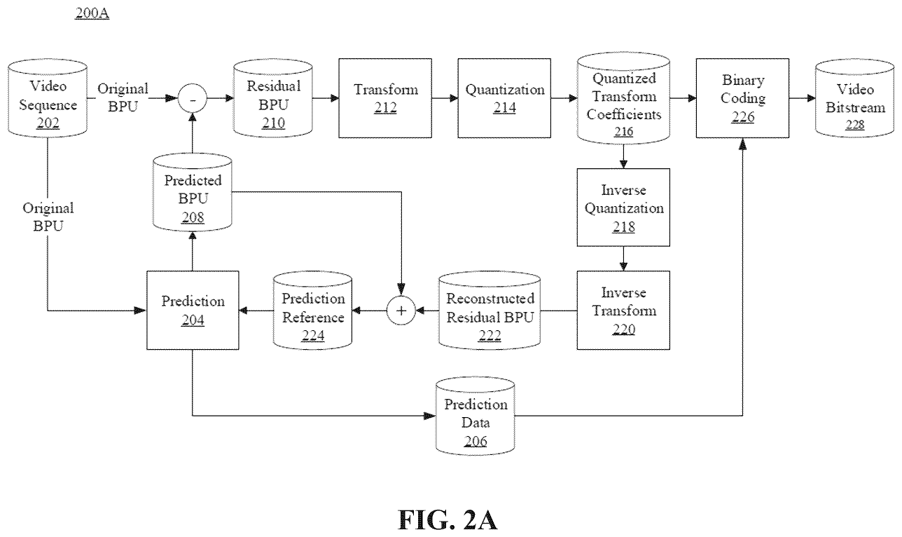

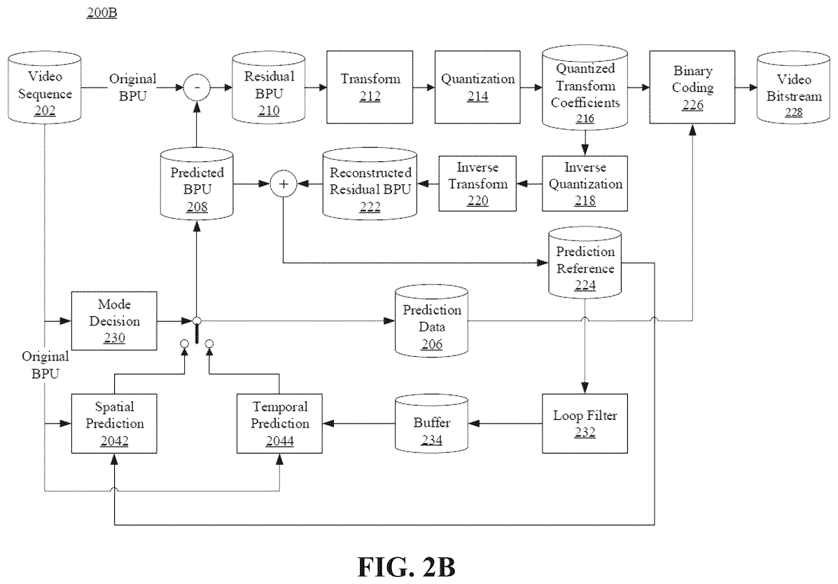

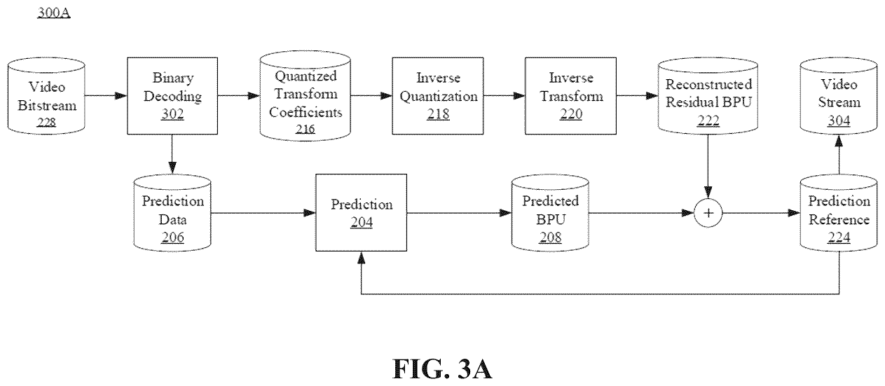

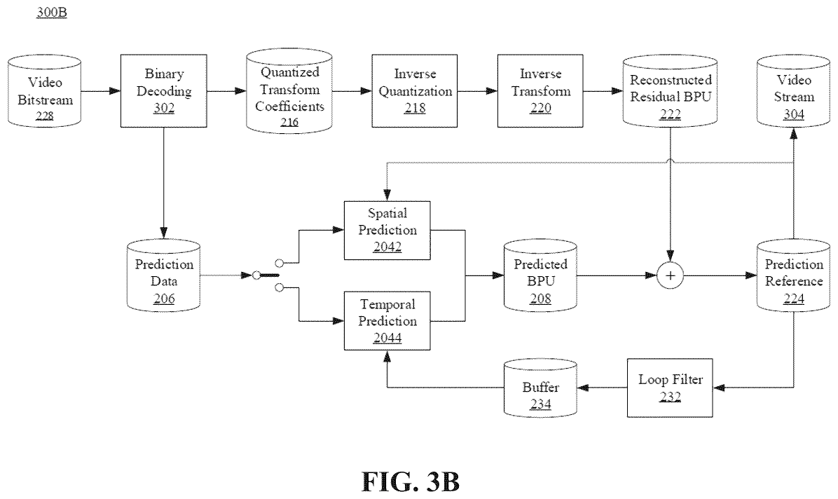

Video coding has multiple stages of operations, examples of which are shown in FIGS. 2A-2B and FIGS. 3A-3B. For each stage, the size of the basic processing units can still be too large for processing, and thus can be further divided into segments referred to as “basic processing sub-units” in the present disclosure. In some embodiments, the basic processing sub-units can be referred to as “blocks” in some video coding standards (e.g., MPEG family, H.261, H.263, H.264/AVC, or AVS), or as “coding units” (“CUs”) in some other video coding standards (e.g., H.265/HEVC, H.266/VVC, or AVS). A basic processing sub-unit can have the same or smaller size than the basic processing unit. Similar to the basic processing units, basic processing sub-units are also logical units, which can include a group of different types of video data (e.g., Y, Cb, Cr, and associated syntax elements) stored in a computer memory (e.g., in a video frame buffer). Any operation performed to a basic processing sub-unit can be repeatedly performed to each of its luma and chroma components. It should be noted that such division can be performed to further levels depending on processing needs. It should also be noted that different stages can divide the basic processing units using different schemes.

For example, at a mode decision stage (an example of which is shown in FIG. 2B), the encoder can decide what prediction mode (e.g., intra-picture prediction or inter-picture prediction) to use for a basic processing unit, which can be too large to make such a decision. The encoder can split the basic processing unit into multiple basic processing sub-units (e.g., CUs as in H.265/HEVC, H.266/VVC, or AVS), and decide a prediction type for each individual basic processing sub-unit.

For another example, at a prediction stage (an example of which is shown in FIGS. 2A-2B), the encoder can perform prediction operation at the level of basic processing sub-units (e.g., CUs). However, in some cases, a basic processing sub-unit can still be too large to process. The encoder can further split the basic processing sub-unit into smaller segments (e.g., referred to as “prediction blocks” or “PBs” in H.265/HEVC, H.266/VVC, or AVS), at the level of which the prediction operation can be performed.

For another example, at a transform stage (an example of which is shown in FIGS. 2A-2B), the encoder can perform a transform operation for residual basic processing sub-units (e.g., CUs). However, in some cases, a basic processing sub-unit can still be too large to process. The encoder can further split the basic processing sub-unit into smaller segments (e.g., referred to as “transform blocks” or “TBs” in H.265/HEVC, H.266/VVC, or AVS), at the level of which the transform operation can be performed. It should be noted that the division schemes of the same basic processing sub-unit can be different at the prediction stage and the transform stage. For example, in H.265/HEVC, H.266/VVC, or AVS, the prediction blocks and transform blocks of the same CU can have different sizes and numbers.

In structure 110 of FIG. 1, basic processing unit 112 is further divided into 3×3 basic processing sub-units, the boundaries of which are shown as dotted lines. Different basic processing units of the same picture can be divided into basic processing sub-units in different schemes.

In some implementations, to provide the capability of parallel processing and error resilience to video encoding and decoding, a picture can be divided into regions for processing, such that, for a region of the picture, the encoding or decoding process can depend on no information from any other region of the picture. In other words, each region of the picture can be processed independently. By doing so, the codec can process different regions of a picture in parallel, thus increasing the coding efficiency. Also, when data of a region is corrupted in the processing or lost in network transmission, the codec can correctly encode or decode other regions of the same picture without reliance on the corrupted or lost data, thus providing the capability of error resilience. In some video coding standards, a picture can be divided into different types of regions. For example, H.265/HEVC, H.266/VVC and AVS provide two types of regions: “slices” and “tiles.” It should also be noted that different pictures of video sequence 100 can have different partition schemes for dividing a picture into regions.

For example, in FIG. 1, structure 110 is divided into three regions 114, 116, and 118, the boundaries of which are shown as solid lines inside structure 110. Region 114 includes four basic processing units. Each of regions 116 and 118 includes six basic processing units. It should be noted that the basic processing units, basic processing sub-units, and regions of structure 110 in FIG. 1 are only examples, and the present disclosure does not limit embodiments thereof.

FIG. 2A illustrates a schematic diagram of an example encoding process 200A, consistent with embodiments of the disclosure. For example, the encoding process 200A can be performed by an encoder. As shown in FIG. 2A, the encoder can encode video sequence 202 into video bitstream 228 according to process 200A. Similar to video sequence 100 in FIG. 1, video sequence 202 can include a set of pictures (referred to as “original pictures”) arranged in a temporal order. Similar to structure 110 in FIG. 1, each original picture of video sequence 202 can be divided by the encoder into basic processing units, basic processing sub-units, or regions for processing. In some embodiments, the encoder can perform process 200A at the level of basic processing units for each original picture of video sequence 202. For example, the encoder can perform process 200A in an iterative manner, in which the encoder can encode a basic processing unit in one iteration of process 200A. In some embodiments, the encoder can perform process 200A in parallel for regions (e.g., regions 114-118) of each original picture of video sequence 202.

In FIG. 2A, the encoder can feed a basic processing unit (referred to as an “original BPU”) of an original picture of video sequence 202 to prediction stage 204 to generate prediction data 206 and predicted BPU 208. The encoder can subtract predicted BPU 208 from the original BPU to generate residual BPU 210. The encoder can feed residual BPU 210 to transform stage 212 and quantization stage 214 to generate quantized transform coefficients 216. The encoder can feed prediction data 206 and quantized transform coefficients 216 to binary coding stage 226 to generate video bitstream 228. Components 202, 204, 206, 208, 210, 212, 214, 216, 226, and 228 can be referred to as a “forward path.” During process 200A, after quantization stage 214, the encoder can feed quantized transform coefficients 216 to inverse quantization stage 218 and inverse transform stage 220 to generate reconstructed residual BPU 222. The encoder can add reconstructed residual BPU 222 to predicted BPU 208 to generate prediction reference 224, which is used in prediction stage 204 for the next iteration of process 200A. Components 218, 220, 222, and 224 of process 200A can be referred to as a “reconstruction path.” The reconstruction path can be used to ensure that both the encoder and the decoder use the same reference data for prediction.

The encoder can perform process 200A iteratively to encode each original BPU of the original picture (in the forward path) and generate predicted reference 224 for encoding the next original BPU of the original picture (in the reconstruction path). After encoding all original BPUs of the original picture, the encoder can proceed to encode the next picture in video sequence 202.

Referring to process 200A, the encoder can receive video sequence 202 generated by a video capturing device (e.g., a camera). The term “receive” used herein can refer to receiving, inputting, acquiring, retrieving, obtaining, reading, accessing, or any action in any manner for inputting data.

At prediction stage 204, at a current iteration, the encoder can receive an original BPU and prediction reference 224 and perform a prediction operation to generate prediction data 206 and predicted BPU 208. Prediction reference 224 can be generated from the reconstruction path of the previous iteration of process 200A. The purpose of prediction stage 204 is to reduce information redundancy by extracting prediction data 206 that can be used to reconstruct the original BPU as predicted BPU 208 from prediction data 206 and prediction reference 224.

Ideally, predicted BPU 208 can be identical to the original BPU. However, due to non-ideal prediction and reconstruction operations, predicted BPU 208 is generally slightly different from the original BPU. For recording such differences, after generating predicted BPU 208, the encoder can subtract it from the original BPU to generate residual BPU 210. For example, the encoder can subtract values (e.g., greyscale values or RGB values) of pixels of predicted BPU 208 from values of corresponding pixels of the original BPU. Each pixel of residual BPU 210 can have a residual value as a result of such subtraction between the corresponding pixels of the original BPU and predicted BPU 208. Compared with the original BPU, prediction data 206 and residual BPU 210 can have fewer bits, but they can be used to reconstruct the original BPU without significant quality deterioration. Thus, the original BPU is compressed.

To further compress residual BPU 210, at transform stage 212, the encoder can reduce spatial redundancy of residual BPU 210 by decomposing it into a set of two-dimensional “base patterns,” each base pattern being associated with a “transform coefficient.” The base patterns can have the same size (e.g., the size of residual BPU 210). Each base pattern can represent a variation frequency (e.g., frequency of brightness variation) component of residual BPU 210. None of the base patterns can be reproduced from any combinations (e.g., linear combinations) of any other base patterns. In other words, the decomposition can decompose variations of residual BPU 210 into a frequency domain. Such a decomposition is analogous to a discrete Fourier transform of a function, in which the base patterns are analogous to the base functions (e.g., trigonometry functions) of the discrete Fourier transform, and the transform coefficients are analogous to the coefficients associated with the base functions.

Different transform algorithms can use different base patterns. Various transform algorithms can be used at transform stage 212, such as, for example, a discrete cosine transform, a discrete sine transform, or the like. The transform at transform stage 212 is invertible. That is, the encoder can restore residual BPU 210 by an inverse operation of the transform (referred to as an “inverse transform”). For example, to restore a pixel of residual BPU 210, the inverse transform can be multiplying values of corresponding pixels of the base patterns by respective associated coefficients and adding the products to produce a weighted sum. For a video coding standard, both the encoder and decoder can use the same transform algorithm (thus the same base patterns). Thus, the encoder can record only the transform coefficients, from which the decoder can reconstruct residual BPU 210 without receiving the base patterns from the encoder. Compared with residual BPU 210, the transform coefficients can have fewer bits, but they can be used to reconstruct residual BPU 210 without significant quality deterioration. Thus, residual BPU 210 is further compressed.

The encoder can further compress the transform coefficients at quantization stage 214. In the transform process, different base patterns can represent different variation frequencies (e.g., brightness variation frequencies). Because human eyes are generally better at recognizing low-frequency variation, the encoder can disregard information of high-frequency variation without causing significant quality deterioration in decoding. For example, at quantization stage 214, the encoder can generate quantized transform coefficients 216 by dividing each transform coefficient by an integer value (referred to as a “quantization scale factor”) and rounding the quotient to its nearest integer. After such an operation, some transform coefficients of the high-frequency base patterns can be converted to zero, and the transform coefficients of the low-frequency base patterns can be converted to smaller integers. The encoder can disregard the zero-value quantized transform coefficients 216, by which the transform coefficients are further compressed. The quantization process is also invertible, in which quantized transform coefficients 216 can be reconstructed to the transform coefficients in an inverse operation of the quantization (referred to as “inverse quantization”).

Because the encoder disregards the remainders of such divisions in the rounding operation, quantization stage 214 can be lossy. Typically, quantization stage 214 can contribute the most information loss in process 200A. The larger the information loss is, the fewer bits the quantized transform coefficients 216 can need. For obtaining different levels of information loss, the encoder can use different values of the quantization parameter or any other parameter of the quantization process.

At binary coding stage 226, the encoder can encode prediction data 206 and quantized transform coefficients 216 using a binary coding technique, such as, for example, entropy coding, variable length coding, arithmetic coding, Huffman coding, context-adaptive binary arithmetic coding, or any other lossless or lossy compression algorithm. In some embodiments, besides prediction data 206 and quantized transform coefficients 216, the encoder can encode other information at binary coding stage 226, such as, for example, a prediction mode used at prediction stage 204, parameters of the prediction operation, a transform type at transform stage 212, parameters of the quantization process (e.g., quantization parameters), an encoder control parameter (e.g., a bitrate control parameter), or the like. The encoder can use the output data of binary coding stage 226 to generate video bitstream 228. In some embodiments, video bitstream 228 can be further packetized for network transmission.

Referring to the reconstruction path of process 200A, at inverse quantization stage 218, the encoder can perform inverse quantization on quantized transform coefficients 216 to generate reconstructed transform coefficients. At inverse transform stage 220, the encoder can generate reconstructed residual BPU 222 based on the reconstructed transform coefficients. The encoder can add reconstructed residual BPU 222 to predicted BPU 208 to generate prediction reference 224 that is to be used in the next iteration of process 200A.

It should be noted that other variations of the process 200A can be used to encode video sequence 202. In some embodiments, stages of process 200A can be performed by the encoder in different orders. In some embodiments, one or more stages of process 200A can be combined into a single stage. In some embodiments, a single stage of process 200A can be divided into multiple stages. For example, transform stage 212 and quantization stage 214 can be combined into a single stage. In some embodiments, process 200A can include additional stages. In some embodiments, process 200A can omit one or more stages in FIG. 2A.

FIG. 2B illustrates a schematic diagram of another example encoding process 200B, consistent with embodiments of the disclosure. Process 200B can be modified from process 200A. For example, process 200B can be used by an encoder conforming to a hybrid video coding standard (e.g., H.26x series). Compared with process 200A, the forward path of process 200B additionally includes mode decision stage 230 and divides prediction stage 204 into spatial prediction stage 2042 and temporal prediction stage 2044. The reconstruction path of process 200B additionally includes loop filter stage 232 and buffer 234.

Generally, prediction techniques can be categorized into two types: spatial prediction and temporal prediction. Spatial prediction (e.g., an intra-picture prediction or “intra prediction”) can use pixels from one or more already coded neighboring BPUs in the same picture to predict the current BPU. That is, prediction reference 224 in the spatial prediction can include the neighboring BPUs. The spatial prediction can reduce the inherent spatial redundancy of the picture. Temporal prediction (e.g., an inter-picture prediction or “inter prediction”) can use regions from one or more already coded pictures to predict the current BPU. That is, prediction reference 224 in the temporal prediction can include the coded pictures. The temporal prediction can reduce the inherent temporal redundancy of the pictures.

Referring to process 200B, in the forward path, the encoder performs the prediction operation at spatial prediction stage 2042 and temporal prediction stage 2044. For example, at spatial prediction stage 2042, the encoder can perform the intra prediction. For an original BPU of a picture being encoded, prediction reference 224 can include one or more neighboring BPUs that have been encoded (in the forward path) and reconstructed (in the reconstructed path) in the same picture. The encoder can generate predicted BPU 208 by extrapolating the neighboring BPUs. The extrapolation technique can include, for example, a linear extrapolation or interpolation, a polynomial extrapolation or interpolation, or the like. In some embodiments, the encoder can perform the extrapolation at the pixel level, such as by extrapolating values of corresponding pixels for each pixel of predicted BPU 208. The neighboring BPUs used for extrapolation can be located with respect to the original BPU from various directions, such as in a vertical direction (e.g., on top of the original BPU), a horizontal direction (e.g., to the left of the original BPU), a diagonal direction (e.g., to the down-left, down-right, up-left, or up-right of the original BPU), or any direction defined in the used video coding standard. For the intra prediction, prediction data 206 can include, for example, locations (e.g., coordinates) of the used neighboring BPUs, sizes of the used neighboring BPUs, parameters of the extrapolation, a direction of the used neighboring BPUs with respect to the original BPU, or the like.

For another example, at temporal prediction stage 2044, the encoder can perform the inter prediction. For an original BPU of a current picture, prediction reference 224 can include one or more pictures (referred to as “reference pictures”) that have been encoded (in the forward path) and reconstructed (in the reconstructed path). In some embodiments, a reference picture can be encoded and reconstructed BPU by BPU. For example, the encoder can add reconstructed residual BPU 222 to predicted BPU 208 to generate a reconstructed BPU. When all reconstructed BPUs of the same picture are generated, the encoder can generate a reconstructed picture as a reference picture. The encoder can perform an operation of “motion estimation” to search for a matching region in a scope (referred to as a “search window”) of the reference picture. The location of the search window in the reference picture can be determined based on the location of the original BPU in the current picture. For example, the search window can be centered at a location having the same coordinates in the reference picture as the original BPU in the current picture and can be extended out for a predetermined distance. When the encoder identifies (e.g., by using a pel-recursive algorithm, a block-matching algorithm, or the like) a region similar to the original BPU in the search window, the encoder can determine such a region as the matching region. The matching region can have different dimensions (e.g., being smaller than, equal to, larger than, or in a different shape) from the original BPU. Because the reference picture and the current picture are temporally separated in the timeline (e.g., as shown in FIG. 1), it can be deemed that the matching region “moves” to the location of the original BPU as time goes by. The encoder can record the direction and distance of such a motion as a “motion vector.” When multiple reference pictures are used (e.g., as picture 106 in FIG. 1), the encoder can search for a matching region and determine its associated motion vector for each reference picture. In some embodiments, the encoder can assign weights to pixel values of the matching regions of respective matching reference pictures.

The motion estimation can be used to identify various types of motions, such as, for example, translations, rotations, zooming, or the like. For inter prediction, prediction data 206 can include, for example, locations (e.g., coordinates) of the matching region, the motion vectors associated with the matching region, the number of reference pictures, weights associated with the reference pictures, or the like.

For generating predicted BPU 208, the encoder can perform an operation of “motion compensation.” The motion compensation can be used to reconstruct predicted BPU 208 based on prediction data 206 (e.g., the motion vector) and prediction reference 224. For example, the encoder can move the matching region of the reference picture according to the motion vector, in which the encoder can predict the original BPU of the current picture. When multiple reference pictures are used (e.g., as picture 106 in FIG. 1), the encoder can move the matching regions of the reference pictures according to the respective motion vectors and average pixel values of the matching regions. In some embodiments, if the encoder has assigned weights to pixel values of the matching regions of respective matching reference pictures, the encoder can add a weighted sum of the pixel values of the moved matching regions.

In some embodiments, the inter prediction can be unidirectional or bidirectional. Unidirectional inter predictions can use one or more reference pictures in the same temporal direction with respect to the current picture. For example, picture 104 in FIG. 1 is a unidirectional inter-predicted picture, in which the reference picture (e.g., picture 102) precedes picture 104. Bidirectional inter predictions can use one or more reference pictures at both temporal directions with respect to the current picture. For example, picture 106 in FIG. 1 is a bidirectional inter-predicted picture, in which the reference pictures (e.g., pictures 104 and 108) are at both temporal directions with respect to picture 104.

Still referring to the forward path of process 200B, after spatial prediction 2042 and temporal prediction stage 2044, at mode decision stage 230, the encoder can select a prediction mode (e.g., one of the intra prediction or the inter prediction) for the current iteration of process 200B. For example, the encoder can perform a rate-distortion optimization technique, in which the encoder can select a prediction mode to minimize a value of a cost function depending on a bit rate of a candidate prediction mode and distortion of the reconstructed reference picture under the candidate prediction mode. Depending on the selected prediction mode, the encoder can generate the corresponding predicted BPU 208 and predicted data 206.

In the reconstruction path of process 200B, if intra prediction mode has been selected in the forward path, after generating prediction reference 224 (e.g., the current BPU that has been encoded and reconstructed in the current picture), the encoder can directly feed prediction reference 224 to spatial prediction stage 2042 for later usage (e.g., for extrapolation of a next BPU of the current picture). The encoder can feed prediction reference 224 to loop filter stage 232, at which the encoder can apply a loop filter to prediction reference 224 to reduce or eliminate distortion (e.g., blocking artifacts) introduced during coding of the prediction reference 224. The encoder can apply various loop filter techniques at loop filter stage 232, such as, for example, deblocking, sample adaptive offsets, adaptive loop filters, or the like. The loop-filtered reference picture can be stored in buffer 234 (or “decoded picture buffer”) for later use (e.g., to be used as an inter-prediction reference picture for a future picture of video sequence 202). The encoder can store one or more reference pictures in buffer 234 to be used at temporal prediction stage 2044. In some embodiments, the encoder can encode parameters of the loop filter (e.g., a loop filter strength) at binary coding stage 226, along with quantized transform coefficients 216, prediction data 206, and other information.

FIG. 3A illustrates a schematic diagram of an example decoding process 300A, consistent with embodiments of the disclosure. Process 300A can be a decompression process corresponding to the compression process 200A in FIG. 2A. In some embodiments, process 300A can be similar to the reconstruction path of process 200A. A decoder can decode video bitstream 228 into video stream 304 according to process 300A. Video stream 304 can be very similar to video sequence 202. However, due to the information loss in the compression and decompression process (e.g., quantization stage 214 in FIGS. 2A-2B), generally, video stream 304 is not identical to video sequence 202. Similar to processes 200A and 200B in FIGS. 2A-2B, the decoder can perform process 300A at the level of basic processing units (BPUs) for each picture encoded in video bitstream 228. For example, the decoder can perform process 300A in an iterative manner, in which the decoder can decode a basic processing unit in one iteration of process 300A. In some embodiments, the decoder can perform process 300A in parallel for regions (e.g., regions 114-118) of each picture encoded in video bitstream 228.

In FIG. 3A, the decoder can feed a portion of video bitstream 228 associated with a basic processing unit (referred to as an “encoded BPU”) of an encoded picture to binary decoding stage 302. At binary decoding stage 302, the decoder can decode the portion into prediction data 206 and quantized transform coefficients 216. The decoder can feed quantized transform coefficients 216 to inverse quantization stage 218 and inverse transform stage 220 to generate reconstructed residual BPU 222. The decoder can feed prediction data 206 to prediction stage 204 to generate predicted BPU 208. The decoder can add reconstructed residual BPU 222 to predicted BPU 208 to generate predicted reference 224. In some embodiments, predicted reference 224 can be stored in a buffer (e.g., a decoded picture buffer in a computer memory). The decoder can feed predicted reference 224 to prediction stage 204 for performing a prediction operation in the next iteration of process 300A.

The decoder can perform process 300A iteratively to decode each encoded BPU of the encoded picture and generate predicted reference 224 for encoding the next encoded BPU of the encoded picture. After decoding all encoded BPUs of the encoded picture, the decoder can output the picture to video stream 304 for display and proceed to decode the next encoded picture in video bitstream 228.

At binary decoding stage 302, the decoder can perform an inverse operation of the binary coding technique used by the encoder (e.g., entropy coding, variable length coding, arithmetic coding, Huffman coding, context-adaptive binary arithmetic coding, or any other lossless compression algorithm). In some embodiments, besides prediction data 206 and quantized transform coefficients 216, the decoder can decode other information at binary decoding stage 302, such as, for example, a prediction mode, parameters of the prediction operation, a transform type, parameters of the quantization process (e.g., quantization parameters), an encoder control parameter (e.g., a bitrate control parameter), or the like. In some embodiments, if video bitstream 228 is transmitted over a network in packets, the decoder can depacketize video bitstream 228 before feeding it to binary decoding stage 302.

FIG. 3B illustrates a schematic diagram of another example decoding process 300B, consistent with embodiments of the disclosure. Process 300B can be modified from process 300A. For example, process 300B can be used by a decoder conforming to a hybrid video coding standard (e.g., H.26x series). Compared with process 300A, process 300B additionally divides prediction stage 204 into spatial prediction stage 2042 and temporal prediction stage 2044, and additionally includes loop filter stage 232 and buffer 234.

In process 300B, for an encoded basic processing unit (referred to as a “current BPU”) of an encoded picture (referred to as a “current picture”) that is being decoded, prediction data 206 decoded from binary decoding stage 302 by the decoder can include various types of data, depending on what prediction mode was used to encode the current BPU by the encoder. For example, if intra prediction was used by the encoder to encode the current BPU, prediction data 206 can include a prediction mode indicator (e.g., a flag value) indicative of the intra prediction, parameters of the intra prediction operation, or the like. The parameters of the intra prediction operation can include, for example, locations (e.g., coordinates) of one or more neighboring BPUs used as a reference, sizes of the neighboring BPUs, parameters of extrapolation, a direction of the neighboring BPUs with respect to the original BPU, or the like. For another example, if inter prediction was used by the encoder to encode the current BPU, prediction data 206 can include a prediction mode indicator (e.g., a flag value) indicative of the inter prediction, parameters of the inter prediction operation, or the like. The parameters of the inter prediction operation can include, for example, the number of reference pictures associated with the current BPU, weights respectively associated with the reference pictures, locations (e.g., coordinates) of one or more matching regions in the respective reference pictures, one or more motion vectors respectively associated with the matching regions, or the like.

Based on the prediction mode indicator, the decoder can decide whether to perform a spatial prediction (e.g., the intra prediction) at spatial prediction stage 2042 or a temporal prediction (e.g., the inter prediction) at temporal prediction stage 2044. The details of performing such spatial prediction or temporal prediction are described in FIG. 2B and will not be repeated hereinafter. After performing such spatial prediction or temporal prediction, the decoder can generate predicted BPU 208. The decoder can add predicted BPU 208 and reconstructed residual BPU 222 to generate prediction reference 224, as described in FIG. 3A.

In process 300B, the decoder can feed predicted reference 224 to spatial prediction stage 2042 or temporal prediction stage 2044 for performing a prediction operation in the next iteration of process 300B. For example, if the current BPU is decoded using the intra prediction at spatial prediction stage 2042, after generating prediction reference 224 (e.g., the decoded current BPU), the decoder can directly feed prediction reference 224 to spatial prediction stage 2042 for later usage (e.g., for extrapolation of a next BPU of the current picture). If the current BPU is decoded using the inter prediction at temporal prediction stage 2044, after generating prediction reference 224 (e.g., a reference picture in which all BPUs have been decoded), the decoder can feed prediction reference 224 to loop filter stage 232 to reduce or eliminate distortion (e.g., blocking artifacts). The decoder can apply a loop filter to prediction reference 224, in a way as described in FIG. 2B. The loop-filtered reference picture can be stored in buffer 234 (e.g., a decoded picture buffer in a computer memory) for later use (e.g., to be used as an inter-prediction reference picture for a future encoded picture of video bitstream 228). The decoder can store one or more reference pictures in buffer 234 to be used at temporal prediction stage 2044. In some embodiments, prediction data can further include parameters of the loop filter (e.g., a loop filter strength). In some embodiments, prediction data includes parameters of the loop filter when the prediction mode indicator of prediction data 206 indicates that inter prediction was used to encode the current BPU.

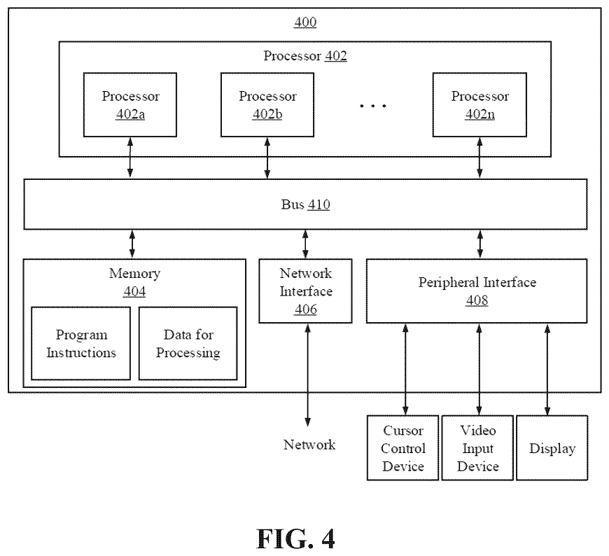

FIG. 4 is a block diagram of an example apparatus 400 for encoding or decoding a video, consistent with embodiments of the disclosure. As shown in FIG. 4, apparatus 400 can include processor 402. When processor 402 executes instructions described herein, apparatus 400 can become a specialized machine for video encoding or decoding. Processor 402 can be any type of circuitry capable of manipulating or processing information. For example, processor 402 can include any combination of any number of a central processing unit (or “CPU”), a graphics processing unit (or “GPU”), a neural processing unit (“NPU”), a microcontroller unit (“MCU”), an optical processor, a programmable logic controller, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), or the like. In some embodiments, processor 402 can also be a set of processors grouped as a single logical component. For example, as shown in FIG. 4, processor 402 can include multiple processors, including processor 402a, processor 402b, and processor 402n.

Apparatus 400 can also include memory 404 configured to store data (e.g., a set of instructions, computer codes, intermediate data, or the like). For example, as shown in FIG. 4, the stored data can include program instructions (e.g., program instructions for implementing the stages in processes 200A, 200B, 300A, or 300B) and data for processing (e.g., video sequence 202, video bitstream 228, or video stream 304). Processor 402 can access the program instructions and data for processing (e.g., via bus 410), and execute the program instructions to perform an operation or manipulation on the data for processing. Memory 404 can include a high-speed random-access storage device or a non-volatile storage device. In some embodiments, memory 404 can include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or the like. Memory 404 can also be a group of memories (not shown in FIG. 4) grouped as a single logical component.

Bus 410 can be a communication device that transfers data between components inside apparatus 400, such as an internal bus (e.g., a CPU-memory bus), an external bus (e.g., a universal serial bus port, a peripheral component interconnect express port), or the like.

For ease of explanation without causing ambiguity, processor 402 and other data processing circuits are collectively referred to as a “data processing circuit” in this disclosure. The data processing circuit can be implemented entirely as hardware, or as a combination of software, hardware, or firmware. In addition, the data processing circuit can be a single independent module or can be combined entirely or partially into any other component of apparatus 400.

Apparatus 400 can further include network interface 406 to provide wired or wireless communication with a network (e.g., the Internet, an intranet, a local area network, a mobile communications network, or the like). In some embodiments, network interface 406 can include any combination of any number of a network interface controller (NIC), a radio frequency (RF) module, a transponder, a transceiver, a modem, a router, a gateway, a wired network adapter, a wireless network adapter, a Bluetooth adapter, an infrared adapter, a near-field communication (“NFC”) adapter, a cellular network chip, or the like.

In some embodiments, optionally, apparatus 400 can further include peripheral interface 408 to provide a connection to one or more peripheral devices. As shown in FIG. 4, the peripheral device can include, but is not limited to, a cursor control device (e.g., a mouse, a touchpad, or a touchscreen), a keyboard, a display (e.g., a cathode-ray tube display, a liquid crystal display, or a light-emitting diode display), a video input device (e.g., a camera or an input interface coupled to a video archive), or the like.

It should be noted that video codecs (e.g., a codec performing process 200A, 200B, 300A, or 300B) can be implemented as any combination of any software or hardware modules in apparatus 400. For example, some or all stages of process 200A, 200B, 300A, or 300B can be implemented as one or more software modules of apparatus 400, such as program instructions that can be loaded into memory 404. For another example, some or all stages of process 200A, 200B, 300A, or 300B can be implemented as one or more hardware modules of apparatus 400, such as a specialized data processing circuit (e.g., an FPGA, an ASIC, an NPU, or the like).

The bi-directional optical flow (BDOF) tool was adopted in VVC standard. BDOF, previously referred to as bi-directional optical flow, was proposed to improve the inter prediction accuracy based on optical flow, and it was first adopted in JEM software. Compared to the JEM version, the BDOF in VVC is a simpler version that requires much less computation, especially in terms of number of multiplications and the size of the multiplier.

In VVC, BDOF is used to refine the bi-prediction signal of a CU at the 4×4 subblock level. BDOF is applied to a CU if it satisfies all the following conditions:
The CU is coded using “true” bi-prediction mode, i.e., one of the two reference pictures is prior to the current picture in display order and the other is after the current picture in display order
The distances (i.e. POC difference) from two reference pictures to the current picture are same
Both reference pictures are short-term reference pictures.
The CU is not coded using affine mode or the SbTMVP merge mode
CU has more than 64 luma samples
Both CU height and CU width are larger than or equal to 8 luma samples
Bi-prediction with CU-level weight (BCW) weight index indicates equal weight
Weighted Prediction (WP) is not enabled for the current CU
Combined inter and intra prediction (CIIP) mode is not used for the current CU

BDOF is only applied to the luma component. As its name indicates, the BDOF mode is based on the optical flow concept, which assumes that the motion of an object is smooth. For each 4×4 subblock, a motion refinement (vₓ, v_{y}) is calculated by minimizing the difference between the L0 and L1 prediction samples. The motion refinement is then used to adjust the bi-predicted sample values in the 4×4 subblock. The following steps are applied in the BDOF process.

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \\ \frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) ) \qquad ( 1 )$$

where I^{(k)}(i,j) are the sample value at coordinate (i,j) of the prediction signal in list k, k=0,1, and shift1 is calculated based on the luma bit depth, bitDepth, as shift1=max (6, bitDepth−6).

Then, the auto- and cross-correlation of the gradients, S₁, S₂, S₃, S₅ and S₆, are calculated as

$${S}_{1} = {\sum }_{( i , j ) ∈ Ω} Abs ( {ψ}_{x} ( i , j ) ) , \\ {S}_{2} = {\sum }_{( i , j ) ∈ Ω} {ψ}_{x} ( i , j ) \cdot Sign ( {ψ}_{y} ( i , j ) ) \\ {S}_{3} = {\sum }_{( i , j ) ∈ Ω} θ ( i , j ) \cdot Sign ( {ψ}_{x} ( i , j ) ) \\ {S}_{5} = {\sum }_{( i , j ) ∈ Ω} Abs ( {ψ}_{y} ( i , j ) ) \\ {S}_{6} = {\sum }_{( i , j ) ∈ Ω} θ ( i , j ) \cdot Sign ( {ψ}_{y} ( i , j ) ) \qquad ( 2 )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \\ {ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \\ θ ( i , j ) = ( {I}^{( 1 )} ( i , j ) ≫ {n}_{b} ) - ( {I}^{( 0 )} ( i , j ) ≫ {n}_{b} ) \qquad ( 3 )$$

where Ω is a 6×6 window around the 4×4 subblock, and the values of nₐ and n_{b} are set equal to min(1, bitDepth−11) and min(4, bitDepth−8), respectively, wherein min(x, y) is a function to get the smaller one of x and y.

The motion refinement (vₓ, v_{y}) is then derived using the cross- and auto-correlation terms using the following:

$${v}_{x} = {S}_{1} > 0 ? clip 3 ( - {th}_{BIO}^{′} , {th}_{BIO}^{′} , - ( ( {S}_{3} \cdot {2}^{{n}_{b} - {n}_{a}} ) ≫ ⌊ {log}_{2} {S}_{1} ⌋ ) ) : 0 \qquad ( 4 )$$

$${v}_{y} = {S}_{5} > 0 ? clip 3 ( - {th}_{BIO}^{′} , {th}_{BIO}^{′} , - ( ( {S}_{6} \cdot {2}^{{n}_{b} - {n}_{a}} -$$

$$( ( {v}_{x} {S}_{2 , m} ) ≪ {n}_{{S}_{2}} + {v}_{x} {S}_{2 , s} ) / 2 ) ≫ ⌊ {log}_{2} {S}_{5} ⌋ ) ) ) : 0$$

where

$${S}_{2 , m} = {S}_{2} ≫ {n}_{{S}_{2}} , {S}_{2 , s} = {S}_{2} \& ( {2}^{{n}_{{S}_{2}}} - 1 ) , {th}_{BIO}^{′} = {2}^{max ( 5 , BD - 7 )} .$$

└·┘ is the floor function, and n_{S}_{₂}=12.

Based on the motion refinement and the gradients, the following adjustment is calculated for each sample in the 4×4 subblock:

$$b ( x , y ) = \qquad ( 5 )$$

$$rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift \qquad ( 6 )$$

These values are selected such that the multipliers in the BDOF process do not exceed 15-bit, and the maximum bit-width of the intermediate parameters in the BDOF process is kept within 32-bit.

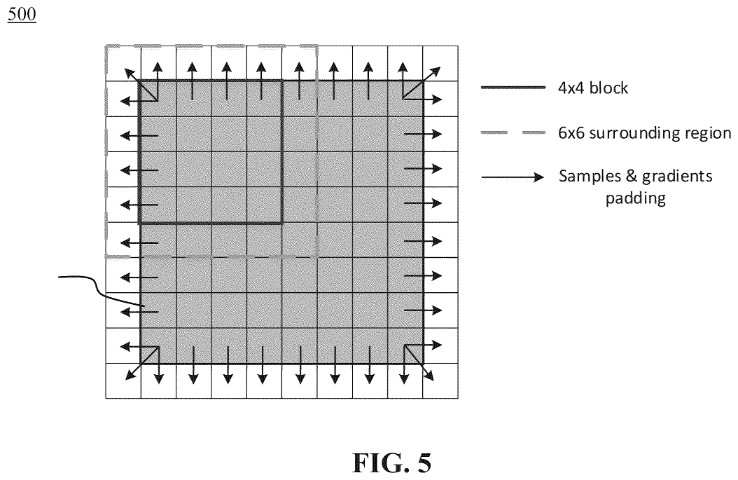

In order to derive the gradient values, some prediction samples I^{(k)}(i,j) in list k (k=0,1) outside of the current CU boundaries need to be generated. As depicted in FIG. 5, the BDOF in VVC uses one extended row/column around the CU's boundaries. In order to control the computational complexity of generating the out-of-boundary prediction samples, prediction samples in the extended area (white positions) are generated by taking the reference samples at the nearby integer positions (using floor ( ) operation on the coordinates) directly without interpolation, and the normal 8-tap motion compensation interpolation filter is used to generate prediction samples within the CU (gray positions). These extended sample values are used in gradient calculation only. For the remaining steps in the BDOF process, if any sample and gradient values outside of the CU boundaries are needed, they are padded (i.e., repeated) from their nearest neighbors.

When the width or height of a CU is larger than 16 luma samples, it will be split into subblocks with width or height equal to 16 luma samples, and the subblock boundaries are treated as the CU boundaries in the BDOF process. The maximum unit size for BDOF process is limited to 16×16. For each subblock, the BDOF process could skipped. When the SAD of between the initial L0 and L1 prediction samples is smaller than a threshold, the BDOF process is not applied to the subblock. The threshold is set equal to (8*W*(H>>1), where W indicates the subblock width, and H indicates subblock height. To avoid the additional complexity of SAD calculation, the SAD between the initial L0 and L1 prediction samples calculated in DMVR process is re-used here.

If BCW is enabled for the current block, i.e., the BCW weight index indicates unequal weight, then bi-directional optical flow is disabled. Similarly, if WP is enabled for the current block, i.e., the luma_weight_1x_flag is 1 for either of the two reference pictures, then BDOF is also disabled. When a CU is coded with symmetric MVD mode or CIIP mode, BDOF is also disabled.

In ECM, to further improve the coding performance, a sample-based BDOF is adopted. In the sample-based BDOF, instead of deriving motion refinement (vₓ, v_{y}) on a block basis, it is performed per sample.

Besides the sample level motion refinement calculation, for the samples out of the CU boundaries, the true sample values instead of padded values are used. Thus, the decoder needs to fetch and interpolate a sample area larger than the current CU for gradient calculation. Similarly, as the true sample value is used for out-boundary samples, there is no need to split the CU into 16×16 subblock for boundary padding.

For threshold checking, the coding block is divided into 8×8 subblocks. For each subblock, whether to apply BDOF or not is determined by checking the SAD between the two reference subblocks against a threshold. If decided to apply BDOF to a subblock, for every sample in the subblock, a sliding 5×5 window is used and the existing BDOF process is applied for every sliding window to derive vₓ and v_{y}. The derived motion refinement (vₓ, v_{y}) is applied to adjust the bi-predicted sample value for the center sample of the window.

As the 8-tap interpolation filter used in VVC is replaced with a 12-tap filter, BDOF also use the 12-tap interpolation filter to generate the predicted samples.

Next, high precision BDOF is described. To improve the precision of motion refinement calculation, the following equations are used to replace equations (4).

First, the horizontal and vertical gradients,

$$\frac{\partial {I}^{( k )}}{\partial x} ( i , j ) and \frac{\partial {I}^{( k )}}{\partial y} ( i , j ) ,$$

k=0,1, of the two prediction signals are computed by directly calculating the difference between two neighboring samples, i.e.,

$$\frac{\partial {I}^{( k )}}{\partial x} ( i , j ) = ( ( {I}^{( k )} ( i + 1 , j ) ≫ shift 1 ) - ( {I}^{( k )} ( i - 1 , j ) ≫ shift 1 ) ) \\ \frac{\partial {I}^{( k )}}{\partial y} ( i , j ) = ( ( {I}^{( k )} ( i , j + 1 ) ≫ shift 1 ) - ( {I}^{( k )} ( i , j - 1 ) ≫ shift 1 ) ) \qquad ( 7 )$$

where I^{(k)}(i,j) are the sample value at coordinate (i,j) of the prediction signal in list k, k=0,1, and shift1 is calculated based on the luma bit depth.

Then, the auto- and cross-correlation of the gradients, S₁, S₂, S₃, S₄, S₅ and S₆, are calculated as

$${S}_{1} = {\sum }_{( i , j ) ∈ Ω} {w}_{ij} \cdot {ψ}_{x} ( i , j ) \cdot {ψ}_{x} ( i , j ) , \\ {S}_{2} = {S}_{4} = {\sum }_{( i , j ) ∈ Ω} {w}_{ij} \cdot {ψ}_{x} ( i , j ) \cdot {ψ}_{y} ( i , j ) \\ {S}_{3} = {\sum }_{( i , j ) ∈ Ω} {w}_{ij} \cdot θ ( i , j ) \cdot {ψ}_{x} ( i , j ) \\ {S}_{5} = {\sum }_{( i , j ) ∈ Ω} {w}_{ij} \cdot {ψ}_{y} ( i , j ) \cdot {ψ}_{y} ( i , j ) \\ {S}_{6} = {\sum }_{( i , j ) ∈ Ω} {w}_{ij} \cdot θ ( i , j ) \cdot {ψ}_{y} ( i , j ) \qquad ( 8 )$$

$$where$$

$${ψ}_{x} ( i , j ) = ( \frac{\partial {I}^{( 1 )}}{\partial x} ( i , j ) + \frac{\partial {I}^{( 0 )}}{\partial x} ( i , j ) ) ≫ {n}_{a} \\ {ψ}_{y} ( i , j ) = ( \frac{\partial {I}^{( 1 )}}{\partial y} ( i , j ) + \frac{\partial {I}^{( 0 )}}{\partial y} ( i , j ) ) ≫ {n}_{a} \\ θ ( i , j ) = ( {I}^{( 1 )} ( i , j ) ≫ {n}_{b} ) - ( {I}^{( 0 )} ( i , j ) ≫ {n}_{b} ) \qquad ( 9 )$$

where wᵢⱼ is a position dependent weight with position (i,j) closer to the current sample, the value of wᵢⱼ being greater, and Ω is a 5×5 window around the current sample, and the values of nₐ and n_{b} are set equal to min(1, bitDepth−11) and min(4, bitDepth−8), respectively, where min(x, y) is a function to get the smaller one of x and y.

In some implementations, regulation is applied by adding an offset to S₁ and S₅ before the derivation of motion refinement (vₓ, v_{y}). The regulation can be expressed as:

$${S}_{1} = {S}_{1} + d , \\ {S}_{5} = {S}_{5} + d \qquad ( 10 )$$

wherein d is the offset whose value could be dependent on the subblock size.

The motion refinement (vₓ, v_{y}) is then derived using the cross- and auto-correlation terms using the following:

$${v}_{x} = \frac{{S}_{3} {S}_{5} - {S}_{2} {S}_{6}}{{S}_{1} {S}_{5} - {S}_{2} {S}_{4}} \\ {v}_{y} = \frac{{S}_{1} {S}_{6} - {S}_{3} {S}_{4}}{{S}_{1} {S}_{5} - {S}_{2} {S}_{4}} \qquad ( 11 )$$

Based on the motion refinement and the gradients, the following adjustment is calculated for each sample

$$b ( x , y ) = \qquad ( 12 )$$

$$rnd ( ( {v}_{x} ( \frac{\partial {I}^{( 1 )} ( x , y )}{\partial x} - \frac{\partial {I}^{( 0 )} ( x , y )}{\partial x} ) + {v}_{y} ( \frac{\partial {I}^{( 1 )} ( x , y )}{\partial y} - \frac{\partial {I}^{( 0 )} ( x , y )}{\partial y} ) + 1 ) / 2 )$$

Finally, the BDOF samples of the CU are calculated by adjusting the bi-prediction samples as follows:

$${pred}_{BDOF} ( x , y ) = ( {I}^{( 0 )} ( x , y ) + {I}^{( 1 )} ( x , y ) + b ( x , y ) + {o}_{offset} ) ≫ shift \qquad ( 13 )$$

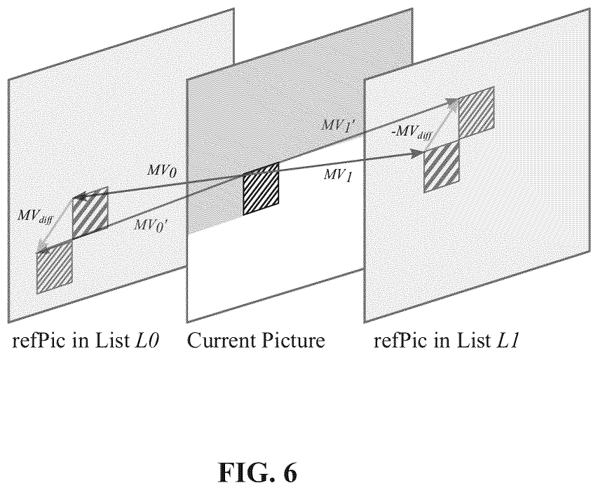

Next, the decoder-side motion vector refinement (DMVR) is described. VVC adopts a bilateral-matching (BM) based decoder side motion vector refinement in bi-prediction operation to increase the accuracy of the MVs of the merge mode. In DMVR, a refined MV is searched around the initial MVs in the reference picture list L0 and reference picture list L1. The BM method calculates the distortion between the two candidate blocks in the reference picture list L0 and list L1. As illustrated in FIG. 6, the SAD between the red blocks based on each MV candidate around the initial MV is calculated. The MV candidate with the lowest SAD becomes the refined MV and used to generate the bi-predicted signal.

In VVC, the application of DMVR is restricted and is only applied for the CUS which are coded with following modes and features:
CU level merge mode with bi-prediction MV
One reference picture is in the past and another reference picture is in the future with respect to the current picture
The distances (i.e. POC difference) from two reference pictures to the current picture are same
Both reference pictures are short-term reference pictures
CU has more than 64 luma samples
Both CU height and CU width are larger than or equal to 8 luma samples
BCW weight index indicates equal weight
WP is not enabled for the current block
CIIP mode is not used for the current block

The refined MV derived by DMVR process is used to generate the inter prediction samples and also used in temporal motion vector prediction for future pictures coding. While the original MV is used in deblocking process and also used in spatial motion vector prediction for future CU coding.

The additional features of DMVR are mentioned in the following sub-clauses.

Next, the searching scheme used in DMVR is described. In DMVR, the search points are surrounding the initial MV and the MV offset obey the MV difference mirroring rule. In other words, any points that are checked by DMVR, denoted by candidate MV pair (MV0, MV1) obey the following two equations:

$$MV {0}^{′} = MV 0 + MV\_offset \qquad ( 14 )$$

$$MV {1}^{′} = MV 1 - MV\_offset \qquad ( 15 )$$

where MV_offset represents the refinement offset between the initial MV and the refined MV in one of the reference pictures. The refinement search range is two integer luma samples from the initial MV. The searching includes the integer sample offset search stage and fractional sample refinement stage.

25 points full search is applied for integer sample offset searching. The SAD of the initial MV pair is first calculated. If the SAD of the initial MV pair is smaller than a threshold, the integer sample stage of DMVR is terminated. Otherwise SADs of the remaining 24 points are calculated and checked in raster scanning order. The point with the smallest SAD is selected as the output of integer sample offset searching stage. To reduce the penalty of the uncertainty of DMVR refinement, it is proposed to favor the original MV during the DMVR process. The SAD between the reference blocks referred by the initial MV candidates is decreased by ¼ of the SAD value.

The integer sample search is followed by fractional sample refinement. To save the calculational complexity, the fractional sample refinement is derived by using parametric error surface equation, instead of additional search with SAD comparison. The fractional sample refinement is conditionally invoked based on the output of the integer sample search stage. When the integer sample search stage is terminated with center having the smallest SAD in either the first iteration or the second iteration search, the fractional sample refinement is further applied.

In parametric error surface based sub-pixel offsets estimation, the center position cost and the costs at four neighboring positions from the center are used to fit a 2-D parabolic error surface equation of the following form:

$$E ( x , y ) = {A ( x - {x}_{min} )}^{2} + {B ( y - {y}_{min} )}^{2} + C \qquad ( 16 )$$

where (xₘᵢₙ, yₘᵢₙ) corresponds to the fractional position with the least cost and C corresponds to the minimum cost value. By solving the above equations by using the cost value of the five search points, the (xₘᵢₙ, yₘᵢₙ) is computed as:

$${x}_{min} = ( E ( - 1 , 0 ) - E ( 1 , 0 ) ) / ( 2 ( E ( - 1 , 0 ) + E ( 1 , 0 ) - 2 E ( 0 , 0 ) ) ) \qquad ( 17 )$$

$${y}_{min} = ( E ( 0 , - 1 ) - E ( 0 , 1 ) ) / ( 2 ( ( E ( 0 , - 1 ) + E ( 0 , 1 ) - 2 E ( 0 , 0 ) ) ) \qquad ( 18 )$$

The value of xₘᵢₙ and yₘᵢₙ are automatically constrained to be between −8 and 8 since all cost values are positive and the smallest value is E(0,0). This corresponds to half peal offset with 1/16th-pel MV accuracy in VVC. The computed fractional (xₘᵢₙ,yₘᵢₙ) are added to the integer distance refinement MV to get the sub-pixel accurate refinement delta MV.

Next, bilinear-interpolation and sample padding are described. In VVC, the resolution of the MVs is 1/16 luma samples. The samples at the fractional position are interpolated using an 8-tap interpolation filter. In DMVR, the search points are surrounding the initial fractional-pel MV with integer sample offset, therefore the samples of those fractional position need to be interpolated for DMVR search process. To reduce the calculation complexity, the bi-linear interpolation filter is used to generate the fractional samples for the searching process in DMVR. Another important effect is that by using bi-linear filter is that with 2-sample search range, the DMVR does not access more reference samples compared to the normal motion compensation process. After the refined MV is attained with DMVR search process, the normal 8-tap interpolation filter is applied to generate the final prediction. In order to not access more reference samples to normal MC process, the samples, which is not needed for the interpolation process based on the original MV but is needed for the interpolation process based on the refined MV, will be padded from those available samples.

Next, the maximum DMVR processing unit is described. When the width or height of a CU are larger than 16 luma samples, it will be further split into subblocks with width or height equal to 16 luma samples. The maximum unit size for DMVR searching process is limit to 16×16.

Next, the multi-pass decoder-side motion vector refinement (MP-DMVR) is described. In ECM, to further improve the coding efficiency, a multi-pass decoder-side motion vector refinement is applied. In the first pass, bilateral matching (BM) is applied to the coding block. In the second pass, BM is applied to each 16×16 subblock within the coding block. In the third pass, MV in each 8×8 subblock is refined by applying bi-directional optical flow (BDOF). The refined MVs are stored for both spatial and temporal motion vector prediction.

In the first pass, block based bilateral matching MV refinement is performed. In the first pass, a refined MV is derived by applying BM to a coding block. Similar to decoder-side motion vector refinement (DMVR), in bi-prediction operation, a refined MV is searched around the two initial MVs (MV0 and MV1) in the reference picture lists L0 and L1. The refined MVs (MV0_pass1 and MV1_pass1) are derived around the initiate MVs based on the minimum bilateral matching cost between the two reference blocks in L0 and L1.

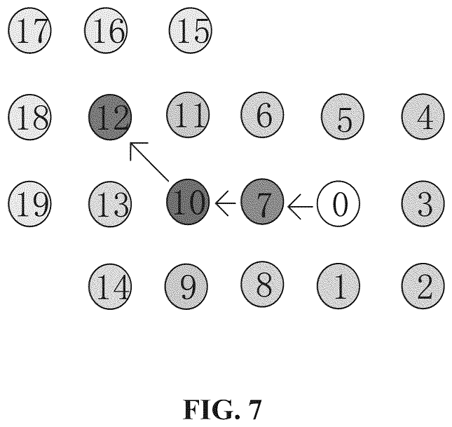

BM performs local search to derive integer sample precision intDeltaMV. The local search applies a 3×3 square search pattern to loop through the search range [−sHor, sHor] in horizontal direction and [−sVer, sVer] in vertical direction, wherein, the values of sHor and sVer are determined by the block dimension, and the maximum value of sHor and sVer is 8 or other values. For example, as in FIG. 7, point 0 is the position to which the initial MV refers. Thus, the points 1 to 8 surrounding the initial position is searched first and the cost of each position is calculated. If point 7 is with minimum cost, then point 7 is set as search center and points 9, 10 and 11 are searched. If cost of point 10 is smaller than the point 7, the search center goes to point 10 and points 12, 13 and 14 are searched. If point 12 is with minimum cost among points 6 to 14, point 12 is set as new search center. If points 10, 11, 13, 15 to 19 surrounding the point 10 are all larger than point 10, then point 12 is the best position and the search process stops.

The bilateral matching cost is calculated as: bilCost=mvDistanceCost+sadCost, wherein sadCost is the SAD between l0 predictor and l1 predictor on each search point and mvDistanceCost is based on intDeltaMV (i.e., the distance between the search point and the initial position). When the block size cbW*cbH is greater than 64, MRSAD cost function is applied to remove the DC effect of distortion between reference blocks. When the bilCost at the center point of the 3×3 search pattern has the minimum cost, the intDeltaMV local search is terminated. Otherwise, the current minimum cost search point becomes the new center point of the 3×3 search pattern and continue to search for the minimum cost, until it reaches the end of the search range.

The existing fractional sample refinement is further applied to derive the final deltaMV. The refined MVs after the first pass is then derived as:

$$MV {0}_{pass 1} = MV 0 + deltaMV \\ MV {1}_{pass 1} = MV 1 - deltaMV \qquad ( 19 )$$

In the second pass, subblock based bilateral matching MV refinement is performed. In the second pass, a refined MV is derived by applying BM to a 16×16 grid subblock. For each subblock, a refined MV is searched around the two MVs (MV0_pass1 and MV1_pass1), obtained on the first pass, in the reference picture list L0 and L1. The refined MVs (MV0_pass2 (sbIdx2) and MV1_pass2 (sbIdx2)) are derived based on the minimum bilateral matching cost between the two reference subblocks in L0 and L1.

For each subblock, BM performs full search to derive integer sample precision intDeltaMV (sbIdx2). The full search has a search range [−sHor, sHor] in horizontal direction and [−sVer, sVer] in vertical direction, wherein, the values of sHor and sVer are determined by the block dimension, and the maximum value of sHor and sVer is 8 or other values.

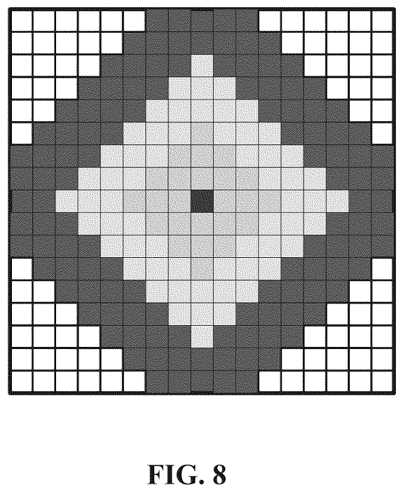

The bilateral matching cost is calculated by applying a cost factor to the SATD cost between two reference subblocks, as: bilCost=satdCost*costFactor. The search area (2*sHor+1)*(2*sVer+1) is divided up to 5 diamond shape search regions shown on FIG. 8. Each search region is assigned a costFactor, which is determined by the distance intDeltaMV (sbIdx2) between each search point and the starting MV, and each diamond region is processed in the order starting from the center of the search area. In each region, the search points are processed in the raster scan order starting from the top left going to the bottom right corner of the region. When the minimum bilCost within the current search region is less than a threshold equal to sbW*sbH, the int-pel full search is terminated, otherwise, the int-pel full search continues to the next search region until all search points are examined. Additionally, if the difference between the previous minimum cost and the current minimum cost in the iteration is less than a threshold that is equal to the area of the block, the search process terminates.

The existing VVC DMVR fractional sample refinement is further applied to derive the final deltaMV (sbIdx2). The refined MVs at second pass is then derived as:

$$MV {0}_{pass 2} ( sbIdx 2 ) = MV {0}_{pass 1} + deltaMV ( sbIdx 2 ) \\ MV {1}_{pass 2} ( sbIdx 2 ) = MV {1}_{pass 1} - deltaMV ( sbIdx 2 ) \qquad ( 20 )$$

where sbIdx2 is the subblock index for second pass of multi-pass DMVR

In the third pass, subblock based bi-directional optical flow MV refinement is performed. In the third pass, a refined MV is derived by applying BDOF to an 8×8 grid subblock. For each 8×8 subblock, BDOF refinement process is applied to derive motion refinement (vₓ, v_{y}) without clipping starting from the refined MV of the parent subblock of the second pass. The method described above can be used. For example, equations (1) to (4) or equations (7) to (10) are invoked to derive (vₓ, v_{y}), denoted as bioMV. After motion refinement derivation, bioMV is rounded to 1/16 sample precision and clipped between −32 and 32.

The refined MVs (MV0_pass3 (sbIdx3) and MV1_pass3 (sbIdx3)) at third pass are derived as:

$$MV {0}_{pass 3} ( sbIdx 3 ) = MV {0}_{pass 2} ( sbIdx 2 ) + bioMV \\ MV {1}_{pass 3} ( sbIdx 3 ) = MV {1}_{pass 2} ( sbIdx 2 ) - bioMV \qquad ( 21 )$$

where sbIdx2 is the subblock index for the second pass of multi-pass DMVR and sbIdx3 is the subblock index for the third pass of multi-pass DMVR.

Next, adaptive decoder-side motion vector refinement is described. In ECM, adaptive decoder side motion vector refinement method is an extension of multi-pass DMVR which consists of the two new merge modes to refine MV only in one direction, either L0 or L1, of the bi prediction for the merge candidates that meet the DMVR conditions. The multi-pass DMVR process is applied for the selected merge candidate to refine the motion vectors, however either MVD0 or MVD1 is set to zero in the 1st pass (i.e., PU level) DMVR. Thus, a new merge candidate list is constructed for adaptive decoder-side motion vector refinement. And the new merge mode for the new merge candidate list is called BM merge in ECM.

The merge candidates for BM merge mode are derived from spatial neighboring coded blocks, TMVPs, non-adjacent blocks, history based motion vector predictors (HMVPs), pair-wise candidate, similar as in the regular merge mode. The difference is that only those meet DMVR conditions are added into the candidate list. The same merge candidate list is used by the two new merge modes. If the list of BM candidates contains the inherited BCW weights and DMVR process is unchanged except the computation of the distortion is made using MRSAD or MRSATD if the weights are non-equal and the bi-prediction is weighted with BCW weights. Merge index is coded as in regular merge mode.

In the current multi-pass DMVR, the first pass and second pass are based on bilateral matching. CU level bilateral matching is performed in the first pass and it is followed by subblock level bilateral matching in the second pass. CU level bilateral matching refines the motion vector at a coarse level and subblock level bilateral matching refines the motion vector at a finer level. However, for the third pass of multi-pass DMVR which is based on optical flow, the refinement grid is fixed and there is only one pass for it. A smaller subblock level refinement gives a finer refinement, while a bigger subblock level refinement gives greater ability of error resilience and thus leads to more stable results in the optical flow calculation. Thus, only one pass of optical flow-based refinement on the fixed grid cannot achieve an accurate and stable results. Moreover, depending on the different video content, the best subblock size for motion vector refinement varies. For example, smooth content may prefer refinement on big subblock and sophisticated content may need small block level refinement. So, motion vector refinement on a fixed grid cannot fit for all the video contents.

The present disclosure provides methods for solving the above problems. In particular, it is proposed to have multiple passes for optical flow-based motion vector refinement. First, dividing the CU into big subblocks and the refinement is performed on the big subblock level. After that, the big subblocks are further divided into smaller subblocks and based on the results of the first pass of the refinement, a second pass of the refinement is performed on the smaller subblock level. In this method, the first pass refinement gives a base refinement to the big subblock and then for each smaller subblock within the big subblock, a more precise motion vector refinement can be obtained through the second pass of the refinement. For the smooth video content, the first pass refinement could bring sufficient motion vector improvement and for the sophisticated video content, the second pass refinement will give more benefits. Thus, both smooth video content and sophisticated video content could gain in the proposed method.

However, the smaller subblock level refinement gives much more complexity. To reduce the complexity, after the first pass of the refinement on the big subblock level, no further subblock splitting is performed. That is, the second pass of the refinement is performed on the subblock with the same size of the first pass of the refinement. In this case, after dividing the CU into the subblocks, two passes of the refinement are performed on each subblock. The first pass of the refinement derives a first motion refinement, and based on the refined motion, the motion compensation is performed on the each subblock and the optical flow based refinement is performed again to find a second motion refinement. The final refined motion is obtained by adding first and second motion refinement.

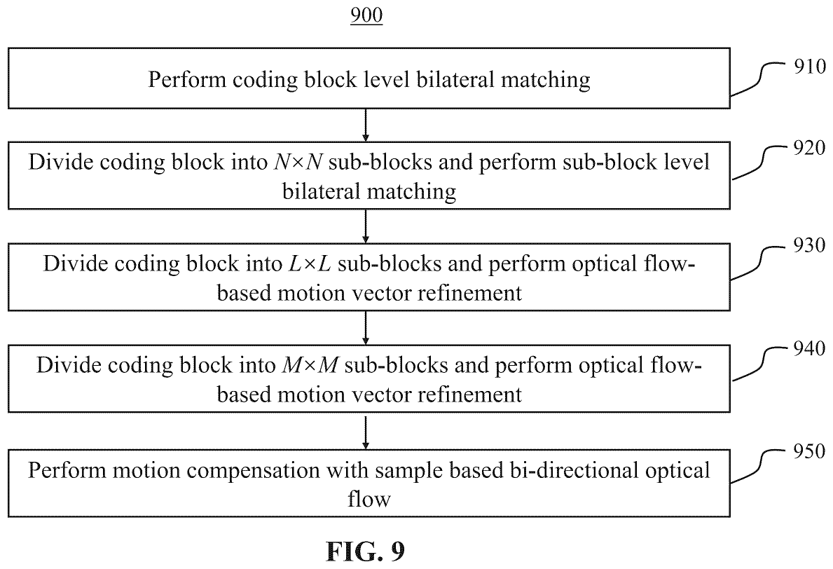

FIG. 9 is a flowchart of an exemplary method 900 for performing motion vector refinement and motion compensation, according to some embodiments of the present disclosure. Method 900 can be performed by an encoder (e.g., by process 200A of FIG. 2A or 200B of FIG. 2B) or a decoder (e.g., by process 300A of FIG. 3A or 300B of FIG. 3B), or performed by one or more software or hardware components of an apparatus (e.g., apparatus 400 of FIG. 4). For example, one or more processors (e.g., processor 402 of FIG. 4) can perform method 900. In some embodiments, method 900 can be implemented by a computer program product, embodied in a computer-readable medium, including computer-executable instructions such as program code, executed by computers (e.g., apparatus 400 of FIG. 4). As shown in FIG. 9, method 900 includes the following steps 910-950.

At step 910, the processor performs coding block level bilateral matching. The block level bilateral matching is performed on a coding block, and can be the first pass in the above-described multi-pass decoder-side motion vector refinement (MP-DMVR) process.

At step 920, the processor divides the coding block into N×N subblocks and performs subblock level bilateral matching. This step can be the second pass of the above-described MP-DMVR. For example, the coding block may have a size of 64×64, and the processor may divide the coding block into a grid of 16×16 subblocks. The processor may then apply the bilateral matching to the plurality of 16×16 subblocks.

At step 930, the processor divides the coding block into L×Z subblocks and performs optical flow-based motion vector refinement on the L×L subblocks. This step can be the third pass of the above-described MP-DMVR—the subblock-level bi-directional optical flow (BDOF) motion vector refinement process. For example, the coding block may have a size of 64×64, and the processor may divide the coding block into a grid of 16×16 or 8×8 subblocks. The processor may then apply the BDOF motion vector refinement process to the plurality of 16×16 or 8×8 subblocks.

At step 940, the processor divides the coding block into M×M subblocks and performs optical flow-based motion vector refinement on the M×M subblocks. Consistent with the disclosed embodiments, the processor may repeat the third pass of the above-described MP-DMVR multiple times, on different sized subblocks. Specifically, at step 940, each of the M×M subblocks is made smaller than each of the L×Z subblocks, i.e., L>M. For example, the L×L subblocks may be 8×8 subblocks, while the M×M subblocks may be 4×4 or 2×2 subblocks.

At step 950, the processor performs motion compensation with sample based bi-direction optical flow.

Although method 900 performs the BDOF motion vector refinement process twice (i.e., performs the third pass of the MP-DMVR twice), it is contemplated that the disclosed embodiments can perform this process in any number of passes, each pass on different sized subblocks. For example, method 900 may be modified to include an additional step 942 (not shown in FIG. 9) after step 940 and before step 950. At step 942, the processor may divide the coding block into a plurality of 2×2 subblocks, and perform a pass of the BDOF motion vector refinement process to the plurality of 2×2 subblocks.

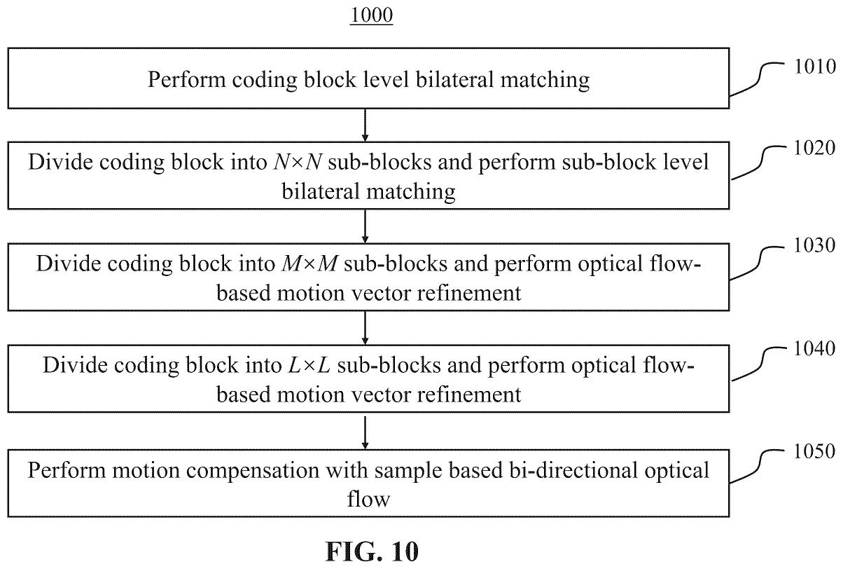

FIG. 10 is a flowchart of an exemplary method 1000 for performing motion vector refinement and motion compensation, according to some embodiments of the present disclosure. Method 1000 can be performed by an encoder (e.g., by process 200A of FIG. 2A or 200B of FIG. 2B) or a decoder (e.g., by process 300A of FIG. 3A or 300B of FIG. 3B), or performed by one or more software or hardware components of an apparatus (e.g., apparatus 400 of FIG. 4). For example, one or more processors (e.g., processor 402 of FIG. 4) can perform method 1000. In some embodiments, method 1000 can be implemented by a computer program product, embodied in a computer-readable medium, including computer-executable instructions such as program code, executed by computers (e.g., apparatus 400 of FIG. 4).

As shown in FIG. 10, method 1000 includes steps 1010-1050. Steps 1010, 1020, and 1050 are identical to steps 910, 920, and 950, respectively. Method 1000 differs from method 900 by first performing a first pass of BDOF motion vector refinement process on the M×M subblocks (step 1030), and then perform a second pass of BDOF motion vector refinement process on the L×L subblocks (step 1040), where L>M.

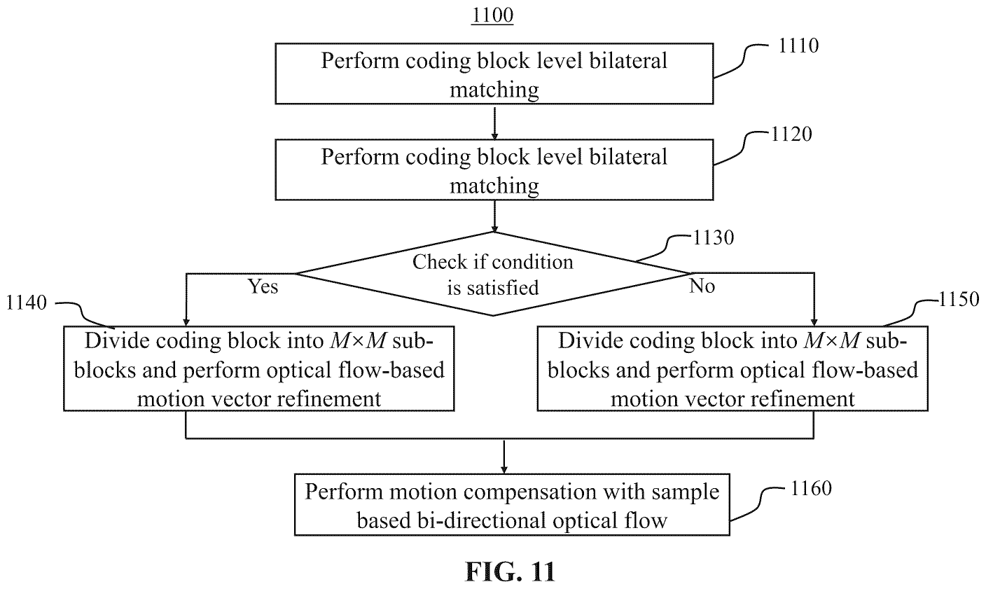

Additionally, in some embodiments, adaptive subblock size can be used for optical flow-based motion vector refinement. For example, FIG. 11 is a flowchart of an exemplary method 1100 for performing motion vector refinement and motion compensation, according to some embodiments of the present disclosure. Method 1100 can be performed by an encoder (e.g., by process 200A of FIG. 2A or 200B of FIG. 2B) or a decoder (e.g., by process 300A of FIG. 3A or 300B of FIG. 3B), or performed by one or more software or hardware components of an apparatus (e.g., apparatus 400 of FIG. 4). For example, one or more processors (e.g., processor 402 of FIG. 4) can perform method 1100. In some embodiments, method 1100 can be implemented by a computer program product, embodied in a computer-readable medium, including computer-executable instructions such as program code, executed by computers (e.g., apparatus 400 of FIG. 4). As shown in FIG. 11, method 1100 includes the following steps 1110-1160.

Specifically, step 1110 is the same as steps 910 and 1010, and step 1120 is the same as steps 920 and 1020, the details of which are not repeated herein.

At step 1130, the processor checks the subblock size (resulted from step 1120) against a condition. If the condition is satisfied, the processor performs the optical flow-based motion vector refinement at a large subblock level, e.g., L×L subblocks (step 1140); and if the condition is not satisfied, the processor performs the optical flow-based motion vector refinement at a small subblock level, e.g., M×M subblocks (step 1150). In the disclosed embodiments, the condition can be based on the area of the coding block, the quantization parameters, or video resolution. For example, the condition may be one of: the coding block is coded using a bi-prediction mode; the coding block has a size exceeding a predetermined threshold; the coding block has a size less than a predetermined threshold; weighted prediction is disabled for the coding block; combined inter and intra (CIIP) is disabled for the coding block; local luma compensation is enabled for the coding block; subblock motion compensation is applied for the coding block; symmetrical motion vector difference is not used; or the coding block is not coded as merge mode with motion vector difference.

Additionally, at step 1160, the processor performs motion compensation with sample based bi-direction optical flow. Step 1160 is the same as steps 950 and 1050.

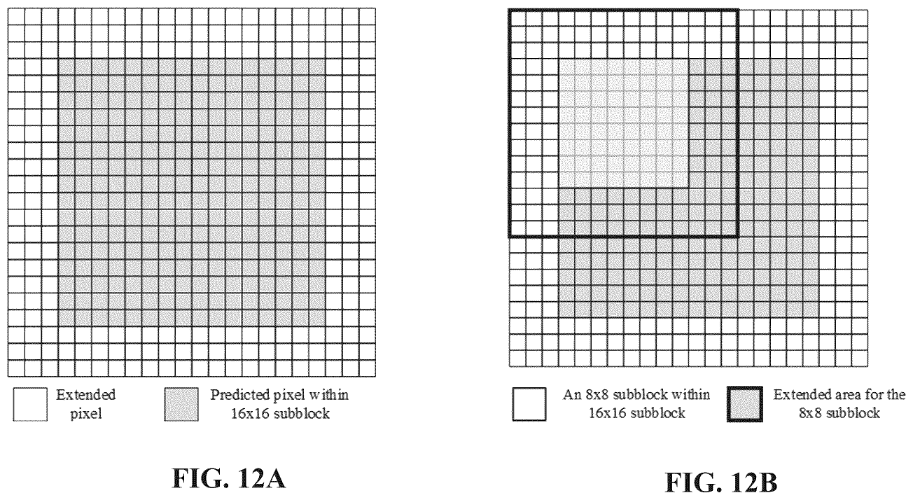

The algorithm for implementing the disclosed optical flow-based motion refinement method is described below in detail. Specifically, in some embodiments, after the second pass of multi-pass DMVR, the refined motion vectors MV0ₚₐₛₛ₂ and MV1ₚₐₛₛ₂ are obtained for each 16×16 subblock, where MV0ₚₐₛₛ₂ is a motion vector of reference picture list0 and MV1ₚₐₛₛ₂ is a motion vector of reference picture list1. Then, based on refined motion vector MV0ₚₐₛₛ₂ and MV1ₚₐₛₛ₂, inter prediction is performed and Pred0_sb16ext and Pred1_sb16ext are obtained, where Pred0_sb16ext is predicted block from reference picture list0 by using MV0ₚₐₛₛ₂ and Pred1_sb16ext is predicted block from reference picture list1 by using MV1ₚₐₛₛ₂. In the inter prediction, interpolation filter could be applied to generate the predicted pixel values on the sub-pel positions. The 8-tap, 12-tap or other interpolation filters can be used. As gradients are needed in optical flow equations, so the predicted block is extended. In this example, shown as FIG. 12A, 3 pixel rows or 3 pixel columns are extended on the four borders of the 16×16 subblock. In some other embodiments, in order to reduce the bandwidth and interpolation calculation, the extended pixels (i.e., the pixels out of the subblock boundaries) can be padded from the boundary pixels within 16×16 subblock instead of actually interpolating them, which is shown in FIG. 5. In some embodiments, to save the computation, the refined motion vectors of two neighboring 16×16 are checked. If two neighboring 16×16 subblock have the same refined motion vectors (i.e., MV0ₚₐₛₛ₂ (sbIdx2) is equal to MV0ₚₐₛₛ₂ (sbIdx1) and MV1ₚₐₛₛ₂ (sbIdx2) is equal to MV1ₚₐₛₛ₂ (sbIdx2)), the two 16×16 neighboring blocks can be merged into a 16×32 or 32×16 subblock. And then the motion vector of the merged subblock will be continually compared with the refined motion vectors of the new neighboring 16×16 subblock. If the motion vectors are still the same, then these two subblocks are further merged. The merge process is repeated to find a subblock as big as possible. Then the inter prediction is performed on the merged subblock. As the first pass of optical flow-based motion refinement is performed on 8×8 subblock level, in some other embodiments, the inter prediction could also be performed for each 8×8 subblock within the 16×16 subblock separately. It won't affect the results.

After the two predicted blocks are obtained. Then for each 8×8 subblock in the 16×16 subblock, the optical flow-based motion vector refinement method can be applied. For example, equations (1) to (4) or equations (7) to (11) are used to derive motion refinement MV_{firstPass}=(vₓ_firstPass, v_{y}_firstPass) for the first pass. Similar with the current BDOF, SAD or SATD between Pred0_sb8 and Pred1_sb8 may be calculated and compared with a threshold, where Pred0_sb8 is the predicted subblock of the current 8×8 subblock from reference picture list 0 which is a subblock of Pred0_sb16ext and Pred1_sb8 is the predicted subblock of the current 8×8 subblock from reference picture list1 which is a subblock of Pred1_sb16ext. If the SAD is less than the threshold, the refinement process is skipped for this 8×8 subblock. The threshold, for example, can be set as k×sbWidth×sbHeight, where sbWidth and sbHeight are the width and height of predicted subblock for SAD or SATD calculation and k is a positive factor. As shown in FIG. 12B, for an 8×8 subblock, the pixels in the extended 14×14 area are needed to derive the motion refinement MV_{firstPass} through equations (1) to (4) or equations (7) to (11). After derivation of motion refinement of the first pass of optical flow-based refinement, the motion vector of each 8×8 subblock can be derived as:

$$MV {0}_{OFpass 1} ( sbIdx 3 ) = MV {0}_{pass 2} ( sbIdx 2 ) + {MV}_{firstPass} ( sbIdx 3 ) \\ MV {1}_{OFpass 1} ( sbIdx 3 ) = MV {1}_{pass 2} ( sbIdx 2 ) - {MV}_{firstPass} ( sbIdx 3 ) \qquad ( 22 )$$

where MV0_{OFpass1} and MV1_{OFpass1} are the motion vector refined by first pass of optical flow-based refinement for reference picture list and reference picture list1, respectively. MV0ₚₐₛₛ₂ and MV1ₚₐₛₛ₂ are the motion vector refined by the second bypass of multi-pass DMVR, MV_{firstPass} is the motion refinement derived in the first pass of optical flow-based motion refinement. sbIdx3 is the index of the subblock for the first pass of optical flow-based motion refinement. sbIdx2 is the index of the subblock for the second pass of multi-pass DMVR.

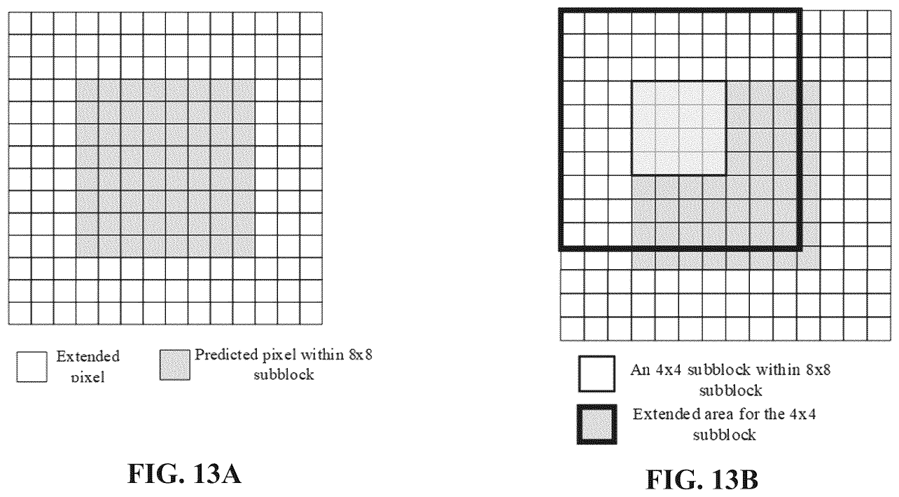

After first pass of optical flow-based motion vector refinement, for each 8×8 subblock, based on the MV0_{OFpass1} and MV1_{OFpass1}, which is obtained in the first pass of optical flow-based motion refinement, two predicted blocks Pred0_sb8ext and Pred1_sb8ext are obtained by inter prediction, where Pred0_sb8ext is predicted block from reference picture list0 by using MV0_{OFpass1} and Pred1_sb8ext is predicted block from reference picture list1 by using MV1_{OFpass1}. In the inter prediction, interpolation filter could be applied to generate the predicted pixel values on the sub-pel positions. The 8-tap, 12-tap or other interpolation filters can be used. As gradients are needed in optical flow equations, so the predicted block is extended. In this embodiment, shown as FIG. 13A, 3 pixel rows and 3 pixel columns are extended on the four borders of the 8×8 subblock. In some other embodiments, in order to reduce the bandwidth and interpolation calculation, the extended pixels are padded from the boundary pixels within the 8×8 subblock instead of actually interpolating them which is shown as FIG. 5. In some embodiments, to save the computation, the refined motion vectors of two neighboring 8×8 are checked. If two neighboring 8×8 subblock have the same refined motion vectors MV0_{OFpass1} and MV1_{OFpass1}, the two neighboring 8×8 blocks can be merged into a 16×8 or 8×16 subblock. And then the motion vector of the merged subblock will be continually compared with refined motion vectors of its neighboring 8×8 subblock. If the motion vectors are still be same, then the two subblocks are further merged. The merge process is repeated to find a subblock as big as possible. Then the inter prediction is performed on the merged subblock. Suppose the second pass of optical flow-based motion refinement is performed on L×L subblock level, in some other embodiments, the inter prediction could also be performed on each L×L subblock within the 8×8 subblock separately. It won't affect the results.

After the two predicted blocks are obtained, the optical flow-based motion vector refinement method can be applied to each L×L subblock in the 8×8 subblock, where L is a positive integer number equal to or less than 8. For example, equations (1) to (4) or equations (7) to (11) are used to derive motion refinement MV_{secondPass}= (vₓ_secondPass, v_{y}_secondPass) for the second pass of optical flow-based motion refinement. Similar with the current BDOF, SAD or SATD between Pred0_sbL and Pred1_sbL may be calculated and compared with a threshold, where Pred0_sbL is the predicted subblock of the current L×L subblock from reference picture list 0 which is a subblock of Pred0_sb8ext and Pred1_sb4 is the predicted subblock of the current L×L subblock from reference picture list 1 which is a subblock of Pred1_sb8ext. If the SAD is less than the threshold, the refinement process is skipped for this L×L subblock. The threshold, for example, can be set to k×sbWidth×sbHeight, where sbWidth and sbHeight are the width and height of predicted subblock for SAD or SATD calculation and k is a positive factor. As shown in FIG. 13B, for an L×L subblock, the pixels in the extended (L+6)×(L+6) area are needed to derive the motion refinement MV_{secondPass} through equations (1) to (4) or equations (7) to (11). After derivation of motion refinement of the second pass of optical flow-based refinement, the motion vector of each L×L subblock can be derived as:

$$MV {0}_{OFpass 2} ( sbIdx 4 ) = MV {0}_{OFpass 1} ( sbIdx 3 ) + {MV}_{secondPass} ( sbIdx 4 ) \\ MV {1}_{OFpass 2} ( sbIdx 4 ) = MV {1}_{OFpass 1} ( sbIdx 3 ) - {MV}_{secondPass} ( sbIdx 4 ) \qquad ( 23 )$$

where MV0_{OFpass2} and MV1_{OFpass2} are the motion vector refined by second pass of optical flow-based refinement for reference picture list0 and reference picture list1, respectively. MV0_{OFpass1} and MV1_{OFpass1} are the motion vectors refined by first pass of optical flow-based refinement for reference picture list0 and reference picture list1, respectively. MV_{secondPass} is the motion refinement derived in the second pass of optical flow-based motion refinement. sbIdx4 is the index of the subblock for the second pass of optical flow-based motion refinement and sbIdx3 is the index of the subblock for the first pass of optical flow-based motion refinement.

The derived MV0_{OFpass2} and MV0_{OFpass1} are the final motion vectors for the current L×L subblock. After that, the existing motion compensation could be performed. Subblock based BDOF or sample based BDOF could also be used in the motion compensation.

In the above-described embodiments, the proposed multi-passes optical flow-based motion refinement follows the first two passes of multi-pass DMVR. By doing it, the multi-pass DMVR is extended to four passes. However, the proposed method is not necessarily combined with multi-pass DMVR. It can be used independently from DMVR. For a bi-predicted CU, if some conditions are satisfied, the proposed multi-pass optical flow-based motion refinement can be performed to refine the motion of the CU. Thus, the input of the proposed multi-pass optical flow base motion refinement can be the motion vector derived in merge mode which is inherited from the previous coded blocks or decoded from the bitstream. And the output of proposed multi-pass optical flow base motion refinement can be further refined by other coding tools before motion compensation. The condition of multi-pass optical flow-based motion refinement could be but limited to:
The CU is coded using “true” bi-prediction mode, i.e., one of the two reference pictures is prior to the current picture in display order and the other is after the current picture in display order
The distances (i.e. POC difference) from two reference pictures to the current picture are same
Both reference pictures are short-term reference pictures.
The CU is not coded using affine mode or the SbTMVP merge mode, local luminance compensated prediction mode, or overlapped block motion compensation.
CU has more than 64 luma samples
Both CU height and CU width are larger than or equal to 8 luma samples
Bi-prediction with CU-level weight (BCW) weight index indicates equal weight
Weighted Prediction (WP) is not enabled for the current CU
Combined inter and intra prediction (CIIP) mode is not used for the current CU
Symmetrical motion vector difference is not used
The CU is not coded as merge mode with motion vector difference

In some embodiments, the difference between two predicted blocks of the current CU, one from reference picture list 0 and the other from reference picture list 1, is calculated and based on the difference, the optical-flow based refinement is skipped. The difference can be sum of absolute differences (SAD) or sum of transformed absolute differences (SATD) of the two predicted blocks.

In one example, the number of the refinement passes is dependent on the difference between the two predicted blocks. If the difference is less than or equal to a threshold, only one pass of optical flow-based refinement is performed (the second pass of optical flow-based refinement is skipped); otherwise two passes of optical flow based refinement is performed. Or if the difference is less than or equal to a first threshold, no optical flow-based refinement is performed; if the difference is larger than the first threshold but less than or equal to a second threshold, only one pass of optical flow-based refinement is performed; if the difference is larger than the second threshold, three passes of optical flow based refinement is performed.

In another example, dependent on the difference between the two predicted blocks, the optical flow-based refinement is skipped or not. First, the two predicted blocks are interpolated by using motion vector before refinement (denoted as MV₀) and the difference between these two predicted blocks are calculated, denoted as D₀. If D₀ is less than or equal to a first threshold, no optical flow-based refinement is performed; if D₀ is larger than a threshold, the first pass of optical flow-based refinement is performed and the motion vector refined, denoted as MV₁. Then another two predicted blocks are obtained by using refined motion vector MV₁ and the difference between these two predicted blocks are calculated, denoted as D₁, and compared with a second threshold. If D₁ is less than or equal to a second threshold, the refinement process terminates; if D₀ is larger than a threshold, the second pass of optical flow-based refinement is performed continually, and the motion vector is refined again.

In yet another example, whether to perform the optical flow-based refinement is decided based on the change of the difference between two predicted blocks. First, the two predicted blocks are interpolated by using motion vector before refinement (denoted as MV₀) and the difference between these two predicted blocks are calculated, denoted as D₀. Then the optical flow-based refinement is performed, and the motion vector is refined, denoted as MV₁. Then another two predicted blocks are obtained by using refined motion vector MV₁ and the difference between these two predicted blocks are calculated, denoted as D₁. If D₁ is larger than D₀, the results of the optical flow-based refinement is reverted. That is, refined motion vector MV₁ is replaced with the original motion vector MV₀; if D₁ is less than or equal to D₀, the result of the optical flow-based refinement is kept, and the following process is performed based on the refinement motion vector MV₁. In some other examples, the changes of the difference is used to decided whether to perform another pass of optical flow based refinement. If D₁ is larger than D₀, the refinement process terminates and refinement motion vector MV₁ is output to the next stage; if D₁ is less than or equal to D₀, another pass of optical flow-based refinement is performed based on MV₁ to get another refined motion vector MV₂. So the number of the pass of the optical flow-based refinement is based on the difference of the differences between two predicted blocks before and after refinement.

Variants of the above-described embodiments can be developed to implement the disclosed optical flow-based motion refinement method. In some embodiments, there can be more than two passes of optical flow-based motion refinement for a CU. For example, the first pass is performed on 8×8 subblock level, the second pass is performed on 4×4 subblock level and the third pass is performed on 2×2 subblock level. As another example, the first pass is performed on 8×8 subblock level, the second pass is performed on 8×8 subblock and the third pass is also performed on 8×8 subblock level.

In some embodiments, the number of the passes of the optical flow-based motion refinement is dependent on the CU size, the sequence resolution or quantization parameters. For example, for large CU, there are fewer passes and for small CU, there are more passes, as usually large CUs have more smooth content which can be refined on a big gird and multiple passes of optical flow-based motion refinement may not be necessary. For example, there is only one pass for a CU having an area larger than or equal to 4096; there are two passes for the CUs having an area less than 4096 but larger than 256; there are three passes for CUs having an area smaller than 256. For another example, for CUs coded with large quantization parameter, there are fewer passes and for CUs coded with small quantization parameter, there are more passes, as larger quantization parameter results in more distortion and thus it needs more passes of refinement. For yet another example, for large video sequences, there are fewer passes and for small video sequences, there are more passes, as usually there are more large CU in large video sequences which don't need more passes of refinement and there are more small CU in small video sequences and they need more passes of refinement.

In some embodiments, the size of the subblock for optical flow-based motion refinement is dependent on CU size, quantization parameter, or video sequence resolution. For example, for a large CU, the optical flow-based motion refinement is performed on a large subblock level and for small CU, the optical flow-based motion refinement is performed on a small subblock level. For example, for CU larger than 256, the optical flow-based refinement is performed on 8×8 subblock level and for CU smaller than or equal to 256, the optical flow-based refinement is performed on 4×4 subblock level. For another example, for CUs coded with large quantization parameters, the optical flow-based motion refinement is performed on a large subblock level and for CUs coded with small quantization parameters, the optical flow-based motion refinement is performed on a small subblock level. For yet another example, for large video sequences, the optical flow-based motion refinement is performed on a large subblock level and for small video sequences, the optical flow-based motion refinement is performed on a small subblock level.

And the adaptive subblock size for optical flow based motion refinement can be combined with multi-pass optical flow-based motion refinement. For example, for CUs having an area larger than 1024, the first pass of optical flow-based motion refinement is performed on 16×16 subblock level and the second pass is performed on 8×8 subblock level; for CUs having an area smaller than or equal to 1024, the first pass of optical flow-based motion refinement is performed on 8×8 subblock level and the second pass is performed on 4×4 subblock level. For another example, for the CUs having an area larger than or equal to 1024, both two passes are performed on 8×8 subblock level; for the CUs having an area less than 1024 but larger than or equal to 512, the first pass is performed on 8×8 subblock level and the second pass is performed on 4×4 subblock level; and for the CUs having an area less than 512, both two passes are performed on 4×4 subblock level. For yet another example, for CUs coded with quantization parameters larger than or equal to 32, the first pass of optical flow-based motion refinement is performed on 16×16 subblock level and the second pass is performed on 8×8 subblock level; for CUs coded with quantization parameter smaller than 32, the first pass of optical flow-based motion refinement is performed on 8×8 subblock level and the second pass is performed on 4×4 subblock level. For yet another example, for video sequence whose resolution larger than 1920×1080, the first pass of optical flow-based motion refinement is performed on 16×16 subblock level and the second pass is performed on 8×8 subblock level; for video sequence whose resolution smaller than 1920×1080 the first pass of optical flow-based motion refinement is performed on 8×8 subblock level and the second pass is performed on 4×4 subblock level.

Moreover, the adaptive subblock size optical flow based motion refinement can be combined with adaptive pass number optical flow based motion refinement. For example, for CUs whose area larger than 1024, there is only one pass of optical flow based motion refinement which is performed on 16×16 subblock level; for CUs whose area is smaller than or equal to 1024, there are two passes of optical flow based motion refinement, of which the first pass is performed on 8×8 subblock level and the second pass is performed on 4×4 subblock level. As another example, for CUs coded with quantization parameters larger than or equal to 32, there are two passes of optical flow based motion refinement, of which the first pass is performed on 16×16 subblock level and the second pass is performed on 8×8 subblock level; for CUs coded with a quantization parameter smaller than 32, there is only one pass of optical flow based motion refinement, which is performed on 8×8 subblock level. As yet another example, for a video sequence having a resolution larger than 1920×1080, there is only one pass of optical flow based motion refinement, which is performed on 16×16 subblock level; for a video sequence having a resolution smaller than 1920×1080, there are two passes of optical flow based motion refinement, of which the first pass is performed on 8×8 subblock level and the second pass is performed on 4×4 subblock level.

The embodiments described in the present disclosure can be freely combined.

In some embodiments, a non-transitory computer-readable storage medium storing a bitstream is also provided. The bitstream can be encoded and decoded according to the disclosed optical flow-based motion refinement method.

In some embodiments, a non-transitory computer-readable storage medium including instructions is also provided, and the instructions may be executed by a device (such as the disclosed encoder and decoder), for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The embodiments may further be described using the following clauses:
1. A video processing method, comprising:
dividing a coding block into a first set of subblocks and a second set of subblocks;
performing a first pass of optical flow-based motion vector refinement on the first set of subblocks; and
performing a second pass of optical flow-based motion vector refinement on the second set of subblocks.
2. The method according to clause 1, wherein sizes of the first set of subblocks are different from sizes of the second set of subblocks.
3. The method according to clause 2, further comprising:
dividing the coding block into a third set of subblocks; and
performing a third pass of optical flow-based motion vector refinement on the third set of subblocks.
4. The method according to clause 2, wherein:
each of the first set of subblocks has a size of 2×2, 4×4, 8×8, or 16×16;
each of the second set of subblocks has a size of 2×2, 4×4, 8×8, or 16×16; and
each of the third set of subblocks has a size of 2×2, 4×4, 8×8, or 16×16.
5. The method according to clause 2, wherein the optical flow-based motion vector refinement is bi-directional.
6. The method according to clause 2, further comprising:
before the first, second, and third passes of optical flow-based motion vector refinement are performed, performing one or more passes of decoder-side motion vector refinement (DMVR) on the coding block.
7. The method according to clause 6, wherein performing the one or more passes of DMVR on the coding block comprises:
performing a first pass of bilateral matching motion vector refinement on the coding block;
dividing the coding block into a fourth set of subblocks; and
performing a second pass of bilateral matching motion vector refinement on the fourth set of subblocks.
8. The method according to clause 2, wherein the first, second, and third passes of optical flow-based motion vector refinement belong to a number of passes of optical flow-based motion vector refinement performed on the coding block, and the method further comprises:
determining the number of passes based on a size of the coding block.
9. The method according to clause 2, further comprising:
determining, based on whether a predetermined condition is satisfied, a subblock size for each of the first set of subblocks, the second set of subblocks, or the third set of subblocks.
10. The method according to clause 9, wherein the predetermined condition comprises at least one of:
the coding block is coded using a bi-prediction mode;
the coding block has a size exceeding a predetermined threshold;
the coding block has a size less than a predetermined threshold;
weighted prediction is disabled for the coding block;
combined inter and intra (CIIP) is disabled for the coding block;
local luma compensation is enabled for the coding block;
subblock motion compensation is applied for the coding block;
symmetrical motion vector difference is not used; or
the coding block is not coded as merge mode with motion vector difference.
11. The method according to clause 1, further comprising:
generating inter prediction samples based on a refined motion vector; and
encoding a bitstream based on the inter prediction samples.
12. The method according to clause 1, further comprising:
decoding a bitstream associated with the video; and
reconstruct the coding block.
13. An apparatus, comprising:
a memory storing computer instructions; and
one or more processors configured to execute the computer instructions, wherein the execution of the computer instruction causes the apparatus to perform operations comprising:
   dividing a coding block into a first set of subblocks and a second set of subblocks;
   performing a first pass of optical flow-based motion vector refinement on the first set of subblocks; and
   performing a second pass of optical flow-based motion vector refinement on the second set of subblocks.
14. The apparatus according to clause 13, wherein sizes of the first set of subblocks are different from sizes of the second set of subblocks.
15. The apparatus according to clause 14, wherein the execution of the computer instruction causes the apparatus to further perform:
dividing the coding block into a third set of subblocks; and
performing a third pass of optical flow-based motion vector refinement on the third set of subblocks.
16. The apparatus according to clause 14, wherein:
each of the first set of subblocks has a size of 2×2, 4×4, 8×8, or 16×16;
each of the second set of subblocks has a size of 2×2, 4×4, 8×8, or 16×16; and
each of the third set of subblocks has a size of 2×2, 4×4, 8×8, or 16×16.
17. The apparatus according to clause 14, wherein the optical flow-based motion vector refinement is bi-directional.
18. The apparatus according to clause 14, wherein the execution of the computer instruction causes the apparatus to further perform:
before the first, second, and third passes of optical flow-based motion vector refinement are performed, performing one or more passes of decoder-side motion vector refinement (DMVR) on the coding block.
19. The apparatus according to clause 18, wherein in performing the one or more passes of DMVR on the coding block, the execution of the computer instruction causes the apparatus to further perform:
performing a first pass of bilateral matching motion vector refinement on the coding block;
dividing the coding block into a fourth set of subblocks; and
performing a second pass of bilateral matching motion vector refinement on the fourth set of subblocks.
20. The apparatus according to clause 14, wherein the first, second, and third passes of optical flow-based motion vector refinement belong to a number of passes of optical flow-based motion vector refinement performed on the coding block, and the execution of the computer instruction causes the apparatus to further perform:
determining the number of passes based on a size of the coding block.
21. The apparatus according to clause 14, wherein the execution of the computer instruction causes the apparatus to further perform:
determining, based on whether a predetermined condition is satisfied, a subblock size for each of the first set of subblocks, the second set of subblocks, or the third set of subblocks.
22. The apparatus according to clause 21, wherein the predetermined condition comprises at least one of:
the coding block is coded using a bi-prediction mode;
the coding block has a size exceeding a predetermined threshold;
the coding block has a size less than a predetermined threshold;
weighted prediction is disabled for the coding block;
combined inter and intra (CIIP) is disabled for the coding block;
local luma compensation is enabled for the coding block;
subblock motion compensation is applied for the coding block;
symmetrical motion vector difference is not used; or
the coding block is not coded as merge mode with motion vector difference.
23. The apparatus according to clause 13, wherein the execution of the computer instruction causes the apparatus to further perform:
generating inter prediction samples based on a refined motion vector; and
encoding a bitstream based on the inter prediction samples.
24. The apparatus according to clause 13, wherein the execution of the computer instruction causes the apparatus to further perform:
decoding a bitstream associated with the video; and
reconstruct the coding block.
25. A non-transitory computer readable storage medium storing a bitstream of a video for processing according to a method comprising:
dividing a coding block into a first set of subblocks and a second set of subblocks;
performing a first pass of optical flow-based motion vector refinement on the first set of subblocks; and
performing a second pass of optical flow-based motion vector refinement on the second set of subblocks.
26. The non-transitory computer readable storage medium according to clause 25, wherein sizes of the first set of subblocks are different from sizes of the second set of subblocks.
27. The non-transitory computer readable storage medium according to clause 26, wherein the method further comprises:
dividing the coding block into a third set of subblocks; and
performing a third pass of optical flow-based motion vector refinement on the third set of subblocks.
28. The non-transitory computer readable storage medium according to clause 26, wherein:
each of the first set of subblocks has a size of 2×2, 4×4, 8×8, or 16×16;
each of the second set of subblocks has a size of 2×2, 4×4, 8×8, or 16×16; and
each of the third set of subblocks has a size of 2×2, 4×4, 8×8, or 16×16.
29. The non-transitory computer readable storage medium according to clause 26, wherein the optical flow-based motion vector refinement is bi-directional.
30. The method according to clause 2, wherein the method further comprises:
before the first, second, and third passes of optical flow-based motion vector refinement are performed, performing one or more passes of decoder-side motion vector refinement (DMVR) on the coding block.
31. The non-transitory computer readable storage medium according to clause 30, wherein performing the one or more passes of DMVR on the coding block comprises:
performing a first pass of bilateral matching motion vector refinement on the coding block;
dividing the coding block into a fourth set of subblocks; and
performing a second pass of bilateral matching motion vector refinement on the fourth set of subblocks.
32. The non-transitory computer readable storage medium according to clause 26, wherein the first, second, and third passes of optical flow-based motion vector refinement belong to a number of passes of optical flow-based motion vector refinement performed on the coding block, and the method further comprises:
determining the number of passes based on a size of the coding block.
33. The non-transitory computer readable storage medium according to clause 26, wherein the method further comprises:
determining, based on whether a predetermined condition is satisfied, a subblock size for each of the first set of subblocks, the second set of subblocks, or the third set of subblocks.
34. The non-transitory computer readable storage medium according to clause 33, wherein the predetermined condition comprises at least one of:
the coding block is coded using a bi-prediction mode;
the coding block has a size exceeding a predetermined threshold;
the coding block has a size less than a predetermined threshold;
weighted prediction is disabled for the coding block;
combined inter and intra (CIIP) is disabled for the coding block;
local luma compensation is enabled for the coding block;
subblock motion compensation is applied for the coding block;
symmetrical motion vector difference is not used; or
the coding block is not coded as merge mode with motion vector difference.
35. The non-transitory computer readable storage medium according to clause 25, wherein the method further comprises:
generating inter prediction samples based on a refined motion vector; and
encoding a bitstream based on the inter prediction samples.
36. The non-transitory computer readable storage medium according to clause 25, wherein the method further comprises:
decoding a bitstream associated with the video; and
reconstruct the coding block.

It should be noted that, the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above-described embodiments can be implemented by hardware, or software (program codes), or a combination of hardware and software. If implemented by software, it may be stored in the above-described computer-readable media. The software, when executed by the processor can perform the disclosed methods. The computing units and other functional units described in the present disclosure can be implemented by hardware, or software, or a combination of hardware and software. One of ordinary skill in the art will also understand that multiple ones of the above described modules/units may be combined as one module/unit, and each of the above described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A video processing method, comprising:
dividing a coding block into a first set of subblocks and a second set of subblocks;
performing a first pass of optical flow-based motion vector refinement on the first set of subblocks; and
performing a second pass of optical flow-based motion vector refinement on the second set of subblocks.

2. The method according to claim 1, wherein sizes of the first set of subblocks are different from sizes of the second set of subblocks.

3. The method according to claim 2, further comprising:
dividing the coding block into a third set of subblocks; and
performing a third pass of optical flow-based motion vector refinement on the third set of subblocks.

4. The method according to claim 2, wherein:
each of the first set of subblocks has a size of 2×2, 4×4, 8×8, or 16×16;
each of the second set of subblocks has a size of 2×2, 4×4, 8×8, or 16×16; and
each of the third set of subblocks has a size of 2×2, 4×4, 8×8, or 16×16.

5. The method according to claim 2, wherein the optical flow-based motion vector refinement is bi-directional.

6. The method according to claim 2, further comprising:
before the first, second, and third passes of optical flow-based motion vector refinement are performed, performing one or more passes of decoder-side motion vector refinement (DMVR) on the coding block.

7. The method according to claim 6, wherein performing the one or more passes of DMVR on the coding block comprises:
performing a first pass of bilateral matching motion vector refinement on the coding block;
dividing the coding block into a fourth set of subblocks; and
performing a second pass of bilateral matching motion vector refinement on the fourth set of subblocks.

8. The method according to claim 2, wherein the first, second, and third passes of optical flow-based motion vector refinement belong to a number of passes of optical flow-based motion vector refinement performed on the coding block, and the method further comprises:
determining the number of passes based on a size of the coding block.

9. The method according to claim 2, further comprising:
determining, based on whether a predetermined condition is satisfied, a subblock size for each of the first set of subblocks, the second set of subblocks, or the third set of subblocks.

10. The method according to claim 9, wherein the predetermined condition comprises at least one of:
the coding block is coded using a bi-prediction mode;
the coding block has a size exceeding a predetermined threshold;
the coding block has a size less than a predetermined threshold;
weighted prediction is disabled for the coding block;
combined inter and intra (CIIP) is disabled for the coding block;
local luma compensation is enabled for the coding block;
subblock motion compensation is applied for the coding block;
symmetrical motion vector difference is not used; or
the coding block is not coded as merge mode with motion vector difference.

11. The method according to claim 1, further comprising:
generating inter prediction samples based on a refined motion vector; and
encoding a bitstream based on the inter prediction samples.

12. The method according to claim 1, further comprising:
decoding a bitstream associated with the video; and
reconstruct the coding block.

13. An apparatus, comprising:
a memory storing computer instructions; and
one or more processors configured to execute the computer instructions, wherein the execution of the computer instruction causes the apparatus to perform operations comprising:
dividing a coding block into a first set of subblocks and a second set of subblocks;
performing a first pass of optical flow-based motion vector refinement on the first set of subblocks; and
performing a second pass of optical flow-based motion vector refinement on the second set of subblocks.

14. The apparatus according to claim 13, wherein sizes of the first set of subblocks are different from sizes of the second set of subblocks.

15. The apparatus according to claim 14, wherein the execution of the computer instruction causes the apparatus to further perform:
dividing the coding block into a third set of subblocks; and
performing a third pass of optical flow-based motion vector refinement on the third set of subblocks.

16. The apparatus according to claim 14, wherein:
each of the first set of subblocks has a size of 2×2, 4×4, 8×8, or 16×16;
each of the second set of subblocks has a size of 2×2, 4×4, 8×8, or 16×16; and
each of the third set of subblocks has a size of 2×2, 4×4, 8×8, or 16×16.

17. The apparatus according to claim 14, wherein the optical flow-based motion vector refinement is bi-directional.

18. The apparatus according to claim 14, wherein the execution of the computer instruction causes the apparatus to further perform:
before the first, second, and third passes of optical flow-based motion vector refinement are performed, performing one or more passes of decoder-side motion vector refinement (DMVR) on the coding block.

19. The apparatus according to claim 18, wherein in performing the one or more passes of DMVR on the coding block, the execution of the computer instruction causes the apparatus to further perform:
performing a first pass of bilateral matching motion vector refinement on the coding block;
dividing the coding block into a fourth set of subblocks; and
performing a second pass of bilateral matching motion vector refinement on the fourth set of subblocks.

20. A non-transitory computer readable storage medium storing a bitstream of a video for processing according to a method comprising:
dividing a coding block into a first set of subblocks and a second set of subblocks;
performing a first pass of optical flow-based motion vector refinement on the first set of subblocks; and
performing a second pass of optical flow-based motion vector refinement on the second set of subblocks.
